(19) United States
(12) Patent Application Publication
(10) Pub. No.: US 2014/0337366 A1
(43) Pub. Date: Nov. 13, 2014

(54) GENEALOGICAL RESEARCH LOGGING SYSTEM AND METHOD

(71) Applicant: ResearchTies, LLC, Provo, UT (US)

(72) Inventor: Jill N. Crandell, Provo, UT (US)

(73) Assignee: ResearchTies, LLC, Provo, UT (US)

(21) Appl. No.: 14/253,440

(22) Filed: Apr. 15, 2014

Related U.S. Application Data
(60) Provisional application No. 61/812,535, filed on Apr. 16, 2013.

(51) Int. Cl. G06F 17/30

(52) U.S. Cl. CPC G06F 17/30106; G06F 17/3061
USPC 707/758

(57) ABSTRACT

In one example, a method for collecting, organizing and processing genealogical research is provided that includes performing various processes at and/or by way of a client device, including, defining an objective and a search, and requesting association of the search with the objective. The example method also includes defining search results generated by the search, and requesting association of URL links and electronic files with the results. The search results are then associated with the defined search, and objectives, searches, and results previously defined and recorded by the user can be found by the user and updated.

### RELATED APPLICATIONS

This application claims priority to U.S. Provisional Patent Application Ser. No. 61/812,535, entitled GENEALOGICAL RESEARCH LOGGING SYSTEM AND METHOD, and filed on Apr. 16, 2013, which is incorporated herein in its entirety by this reference.

### FIELD OF THE INVENTION

Embodiments of the present invention generally relate to genealogical and historical research and related processes. More particularly, embodiments of the invention relate to, among other things, systems, hardware, computer-readable media, and methods for capturing genealogical and historical research that will be or has been performed, and generating reports using the captured information.

### BACKGROUND

With the digitization of vast amounts of historical information, genealogical researchers and historians have ready access to more data than ever before. However, this large amount of data, coupled with the inherent complexity of genealogical and historical research, can present problems to the researcher that cannot be readily resolved by current manual or computerized methods for logging and tracking the research. Manual methods are particularly problematic because they are simply inadequate to deal with processing and examining the large amounts of data, and disparate sources of data, that are available to researchers. Moreover, where tracking systems do exist, they typically lack the capability to permit researchers to search their logs on multiple variables within the bounds of a single search.

As another example, some systems are constrained by the fact that there are generally a limited number of tags or keywords that can be used. Further aggravating this problem is the fact that the researcher typically has to add multiple tags to each entry to enable subsequent searches based on the variables to which those tags respectively correspond. However, this approach is complicated and cumbersome. As well, where multiple logs are created, it can be difficult, if not impossible, for a researcher to search for one or more tags across multiple logs.

In light of the foregoing, it would be useful to be able to search on multiple variables within a single search. Likewise, it would be desirable to be able to record all research in one log, rather than needing to create multiple logs or notebooks in order to facilitate retrieval of the materials. Finally, it would be useful to save research results, even if incomplete, so that they can be readily accessed and the research continued later.

### BRIEF DESCRIPTION OF THE DRAWINGS

In order to describe the manner in which at least some aspects of example embodiments of the invention can be obtained, a more particular description of embodiments of the invention will be rendered by reference to specific embodiments thereof which are illustrated in the appended drawings. Understanding that these drawings depict only example embodiments of the invention and are not therefore to be considered to be limiting of its scope, embodiments of the invention will be described and explained with additional specificity and detail through the use of the accompanying drawings, in which:

FIG. 1 discloses aspects of an example operating environment for one or more embodiments of the invention;

FIG. 2 discloses aspects of an example server;

FIG. 3 discloses aspects of an example client device;

FIG. 4 discloses example processes for adding and/or refining information concerning one or more research objectives, searches, and/or search results;

FIGS. 4a-4o are directed to an example flow chart for a process for adding information, and corresponding example UIs that can be used in connection with the processes disclosed in FIG. 4;

FIGS. 5-5l are directed to an example flow chart for a process for adding information to lists, and corresponding example UIs that can be used in connection with the processes disclosed in FIG. 5;

FIGS. 6-6c are directed to an example flow chart for a process for searching for objectives, and corresponding example UIs that can be used in connection with the processes disclosed in FIG. 6;

FIG. 7 is directed to an example flow chart for a process for searching for searches;

FIGS. 8-8c are directed to an example flow chart for a process for searching for results, and corresponding example UIs that can be used in connection with the processes disclosed in FIG. 8; and

FIGS. 9-9a are directed to an example flow chart for a process for creating and editing a “to do” list, and corresponding example UIs that can be used in connection with the processes disclosed in FIG. 9.

### DETAILED DESCRIPTION OF SOME EXAMPLE EMBODIMENTS

Embodiments of the present invention relate generally to genealogical and historical research and related processes. More particularly, embodiments of the invention relate to, among other things, systems, hardware, computer-readable media, and methods for capturing genealogical research that will be or has been performed, and generating reports using the captured information. Embodiments of the invention represent a new approach to organizing and tracking genealogical research at least insofar as they enable the researcher to bring computing power and resources to bear on problems that cannot be readily resolved, if at all, by manual methods or by known computer-based research logging and organizational systems. In fact, at least some of the problems resolved by embodiments of the invention did not exist prior to the advent of computer-based research systems.

In at least some embodiments, the research client operates in conjunction with a browser so as to provide a web-based interface to a user of a client device, and by way of which a user can communicate and interact with a research application hosted on a server or other device. Thus, a web page may include a portal, which can be protected by a username and password for example, that enables an authorized user to access prior research results and/or to commence a new research project. Embodiments of the invention are not limited to use of a web-based interface however, and any other suitable interface(s) can additionally or alternatively be employed.

In general, example embodiments of the invention reflect the way in which genealogists conduct research. Thus, at least some example methods are hierarchically organized and performed in that, at the top of the hierarchy, an objective is defined that is then further developed through searches that are defined and implemented and, finally, at the bottom of the hierarchy, the results produced by those searches. Thus, the efforts of a researcher can be easily organized by objectives, then searches, then results.

The logs produced as a result of the disclosed methods are searchable by multiple variables simultaneously, where such variables include, but are not limited to, any combination of one or more of: person, family, surname, place, record type, event, source, repository, call number, film number, date, researcher, and keyword. As well, genealogical data can also be searched by complete or incomplete objective; positive, nil, or “to do” searches; and positive or nil results.

Embodiments of the invention may include a variety of other useful functionalities as well. For example, research applications, research clients, and associated methods may include or use a multi-variable search engine that enables a user to search genealogical information on multiple variables in the same search.

Embodiments of the search engine operate to return search hits for individuals, families, or surnames, to name a few examples of search variables. For example, searching for a family will return hits for work, that is, research, focused on the family, as well as those focused on each individual in the family, for example, husband, wife, and each child. Searching for a surname will return work done for a surname, as well as all families where the husband has that surname, and all individuals with the same surname.

Another example of a function that can be performed in connection with embodiments of the invention is the generation of a “to do” research list. After a user enters searches that need to be conducted, the “to do” list can be retrieved by conducting a find/select operation for searches that do not yet have results attached. With the multi-variable search engine, the “to do” list can be limited to work that needs to be completed, for example, at a specific repository, for a particular family, and any other combination of searchable variables.

As well, embodiments of the invention facilitate the recording of information discovered during research, such as URL links to research results or documents for example, and also enable the preservation of digital documents. For example, some embodiments include a “drag and drop” functionality that enables a user to link images of documents into the research log.

By loading document files to the application server or servers, users create a back-up of their research for long-term preservation, such as on a cloud storage system. By storing links to digital research results, and providing the ability to search on multiple variables, embodiments of the invention can significantly increase the efficiency and quality of researchers' analysis since the user can easily open and study all related documents.

At least some embodiments of the invention enable multiple users to access the same research log. For example, one such embodiment enables users such as relatives, organizations, research companies, and others to use the same log and coordinate research efforts. This embodiment records which user added each entry, and all data is visible to all users. The sponsor of the log can determine the type of access that each researcher will have, such as read/write or read-only access, for example.

Moreover, at least some embodiments of the invention, such as a research client for example, employ a graphical user interface (UI) having a variety of tools and interface options that may enhance the effectiveness and efficiency of the efforts of a user. By way of illustration, one such UI may include ditto down arrows that duplicate data entry by copying the data in the preceding record to the same field in the current record. This greatly simplifies complete recording of multiple results found in the same source document.

Another example of a tool for improving efficiency is a UI that may include the ability to download bibliographic source citation data from online catalogs and import it to the invention without requiring data entry by hand. Researchers are enabled to select from a catalog the desired source to import, which then may be instantly available for use to plan upcoming searches.

As another example, the UI may include one or more dropdown boxes that enable data entry to be performed in a consistent and efficient manner. Thus, the UI enables the user to retrieve information and documents without the concern that a tag may have been entered differently in various sessions of research. The dropdown boxes also enable personalization in that items listed in the dropdown boxes can be entered by the user. Every account is unique and tailored to the needs of the user associated with that account. Further, “add” buttons enable a user to add dropdown items while in the process of data entry.

At least some embodiments of the invention employ a UI compatible with fields in some genealogy data management programs for PC, Mac, and online applications. Such fields include, but are not limited to, any combination of one or more of: individuals, marriages, surnames, places, source citations, and repositories. The fields are linked between the UI and data management programs to access data already entered there, eliminating the need for duplicate data entry in the logging application.

By creating compatibility between genealogical programs, the invention may also import and use data already entered in other applications, for example, by importing a gedcom file. In addition, at least one embodiment includes certification with FamilySearch Family Tree, enabling users to send the results of their research to a public tree and share their genealogical data without duplicate data entry. Users are able to send and attach source citations, URL links, and/or digital images of relevant documents from the invention to the corresponding person in Family Tree.

Yet another useful aspect of at least some embodiments of the UI is a “recent activity” element. Among other things, the “recent activity” feature on the home page allows the user to return to recent data entry items to continue where the user left off in a previous research session.

Still other useful aspects of embodiments of the invention concern reporting functionality. For example, one or more of such embodiments can employ report headings that indicate the variables of the find/select operation that are limiting the results generated in that report. Thus, a user viewing the report can quickly determine what the defining parameters of the report are. Although the default sort order can be chronological, the user may choose to sort the report on any one of several variables, including but not limited to: person, family, surname, jurisdiction, repository, record type, objective, or researcher.

Reports generated in connection with embodiments of the invention can take any suitable form, examples of which include, but are not limited to, portable document format (.pdf), Word documents, Excel documents, .txt files, HTML files, and any combination of the foregoing. In at least some embodiments, .pdf reports can be generated that maintain active hyperlinks to the documents and/or other materials on file in association with that report. Thus, a user who generates a .pdf file can electronically share the file with others, for example a client or relative, which will provide them the ability to also view the linked documents or other materials. Finally, reports generated in connection with various embodiments, such as by way of a find/select process for example, can be memorized. For example, users will frequently want to conduct a search for their “to do” items at a repository where they regularly research. By memorizing the report, the user can create a current list with one click. There is no need to repeatedly set the same variables each time an updated list is needed.

Finally, while embodiments of the invention provide a variety of useful functionalities in terms of research efforts based upon particular people, or groups of people such as families, the scope of the invention is not so limited. For example, embodiments of the invention can additionally, or alternatively, employ historical templates that define and/or implement a locality survey that is tied to a place rather than people. As part of genealogical research, historians conduct surveys of available source materials to determine what is relevant to the current project. The historical templates can be tailored to record source information related to places rather than to people.

In addition to functionalities such as those noted above, embodiments of the invention may also provide for billing and related functionalities. For example, because genealogical research efforts are often billed on an hourly basis, a time tracking system can be provided that can take the form of, for example, a toggle switch on the toolbar of a UI. The user can click the icon to start the timer and open the timesheet. The date and time are auto-filled, and the user adds a narrative of the activity or research that is being done. When finished, the users click the timer to record the end time and record the time spent. The time tracking element also keeps a running total until the timer is reset. This feature may be particularly helpful to professional researchers who bill by the hour, students who need to report their research hours to professors, and any family historian who is tracking their experience hours to qualify for credentialing.

### A. DEFINITIONS

To aid in the understanding of this disclosure, various definitions are set forth below. These definitions are not intended to limit the scope of the invention in any way.

ALTERNATE SPELLING: Spelling was not standardized in the past the way it is today. Genealogists frequently need to search for different spellings of the names they are researching. Embodiments of the invention provide a place to record spelling variations in the “Add Surname” template so that Results for a Find/Select for a Surname will return all related spellings.

DOCUMENT NUMBER: Researchers need to track the documents that are found as the result of their research. With paper files, the documents are numbered and placed in files. In addition to numbering systems used to track paper files, many people want to record the file and path to an electronic document. Embodiments of the invention provide a field for users to record their document numbers or electronic file names.

EVENT: In the “Add Objective” templates, an “event” is a life event. Researchers frequently focus on events like birth, marriage, and death, but they also focus on migration, military service, and other important happenings in their ancestors' lives.

FAMILYSEARCH ID: FamilySearch is a worldwide organization that promotes family history research and provides many tools at no cost (FamilySearch.org). FamilySearch Family Tree is an online program where the public can donate/record their research linked into family relationships. Every person in the database has an ID number. Genealogists frequently want to track the FamilySearch ID number that is associated with the person they are researching.

FILE: When a researcher finds a document related to their research, they are able to save an electronic copy of the file (photo, scanned image, downloaded document) and upload it to a research application server, for example, for preservation. “Add File” is located in the Results template of the main form.

FILM NUMBER: Many of the records of the world have been microfilmed for preservation. Recording the microfilm number is comparable to recording a book call number for future reference and for citations.

FIND/SELECT: The Find/Select operation is a term referring to the process of “Search Your Records” in embodiments of the invention. Because the word “search” has a different meaning in the research process, this is a way to distinguish between a search while conducting research and a search of the records stored in the research application server and/or elsewhere.

GEDCOM: This acronym stands for genealogical data communications. A gedcom file is the format that was designed for communication between genealogical programs. Users create a gedcom file in one program and import the data into another.

GENERAL SOURCE: In the “Add Search” template, users have the option to indicate the jurisdiction of the source. Some records were not created by an entity with a specific jurisdiction, so these are referred to as general sources. Personal letters, pedigree charts, family history publications, and biographies are examples of general sources.

JURISDICTION: Record keepers have authority to record events that occurred in a specific locality. The boundaries of their authority are referred to as their jurisdiction. For example, the jurisdiction of a land book recorded by a county clerk would be the specific county where the book was being kept.

LINK: When an online document or other information is found by a researcher, the researcher records the URL and creates a link to the site where it was found. This link is recorded in the Results template and allows the researcher to return and view the document again in the future.

LOCALITY SURVEY: Genealogists and historians conduct locality surveys to determine what source materials exist for their area of research, but also to learn about boundary changes and the history of the locality. This type of research is based on places rather than people.

MARRIAGE ID: Genealogical data programs assign ID numbers to each marriage in the database. These numbers are identifiers that are helpful to record and use in embodiments of the invention.

NAME IN RECORD: Because spelling and name usage can change for the same person over time, researchers need to record the name of the person as it was recorded in each original record. Sometimes these differences are in spelling, maiden and married surnames, and usage of nicknames, initials, or middle names.

NIL SEARCH: When a search is conducted and nothing is found that is relevant to the scope and/or purpose of the search, it is referred to as a nil search.

NIL SEARCH DATE: This is the date that a nil search was conducted.

OBJECTIVE: An objective is a goal or purpose for the research being conducted. Genealogists are most efficient and effective when they set a goal and search to specifically address that issue.

PERSONAL ID: Genealogical data programs assign ID numbers to each individual in the database. These numbers are identifiers that are helpful to record and use in embodiments of the invention.

PRELIMINARY SURVEY: Before beginning original research, genealogists conduct a preliminary survey. Typically, a researcher searches for work that has already been done, by that researcher and/or others, among online pedigree sites, published genealogies, home sources of relatives, journals and diaries, biographical sketches, and more.

RECENT ACTIVITY: In embodiments of the invention, there is an area on the home page referred to as “Recent Activity.” This is a list of data entry that was done in the previous three sessions of work. The list is hyperlinked to each item, allowing users to return quickly to what they were doing the last few times they worked.

RECORD GROUP OR RECORD TYPE: Sources come in hundreds of formats, but they generally fall into categories referred to as record groups or record types. For example, we have birth, marriage and death records that are all considered vital records. Burial registers, grave markers, cemetery plat maps, and other sexton's records are all considered cemetery records. Classifying searches by record type allows users to study which records they have looked at and which ones might still be needed.

REPOSITORY: Records are housed in a variety of repositories. Since genealogists work beyond libraries and archives and conduct research in cemeteries, historical societies, online websites, and more, the term repository refers to the entity that is housing the record.

RESEARCH LOG: Embodiments of the invention include an online research log. Genealogists need to record their research and the results of their work so that they are able to determine what has been done, what has not been done, and where they still need to work.

RESULT: When conducting searches, the findings are considered the results of the search. Results can be positive or nil depending on what was or was not found.

SCOPE: Every researcher has to place limits on the searches being conducted. They determine if they are looking for a person, every member of a family, or all entries for a surname. They limit their search by jurisdiction, and frequently only a specific time period is searched. The scope of the search is the extent of the record that will be or has been searched.

SEARCH: A search is the process of looking in a record to find results.

SOURCE: The records being searched are referred to as sources.

### B. EXAMPLE OPERATING ENVIRONMENTS

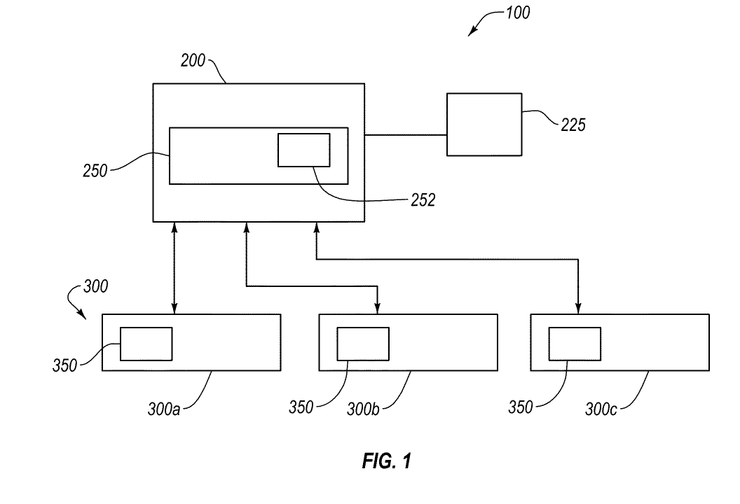

Embodiments of the invention can be employed in any suitable environment, and the scope of the invention is not limited to any particular environment. FIG. 1 discloses one example of an operating environment 100 in which one or more embodiments of the invention can be employed. The operating environment 100 may be a network such as a local area network, a wide area network, or any other networked configuration, or a portion of a network. Some, part, or all of the operating environment 100 may comprise a wireless communication network, although that is not required. The operating environment 100, some or all of which may constitute a virtual infrastructure, may include various devices including servers and other computers that are interconnected. Moreover, any combination of the elements indicated in the operating environment 100 may be implemented in a cloud or internet environment or other networked environment. Some or all of the operating environment 100 may comprise a portion of a cloud based operating environment.

Part or all of the operating environment 100 may be implemented as a virtual infrastructure, although that is not required. The operating environment 100, however implemented, may comprise physical devices, virtual devices, or a combination of both physical devices and virtual devices. Examples of devices that may be implemented in physical and/or virtual form include client devices and servers, such as application servers for example. Moreover, the data stored in the operating environment 100 and/or the software running in the operating environment 100 may be cloud based, network based, or single computer based or any combination of the foregoing.

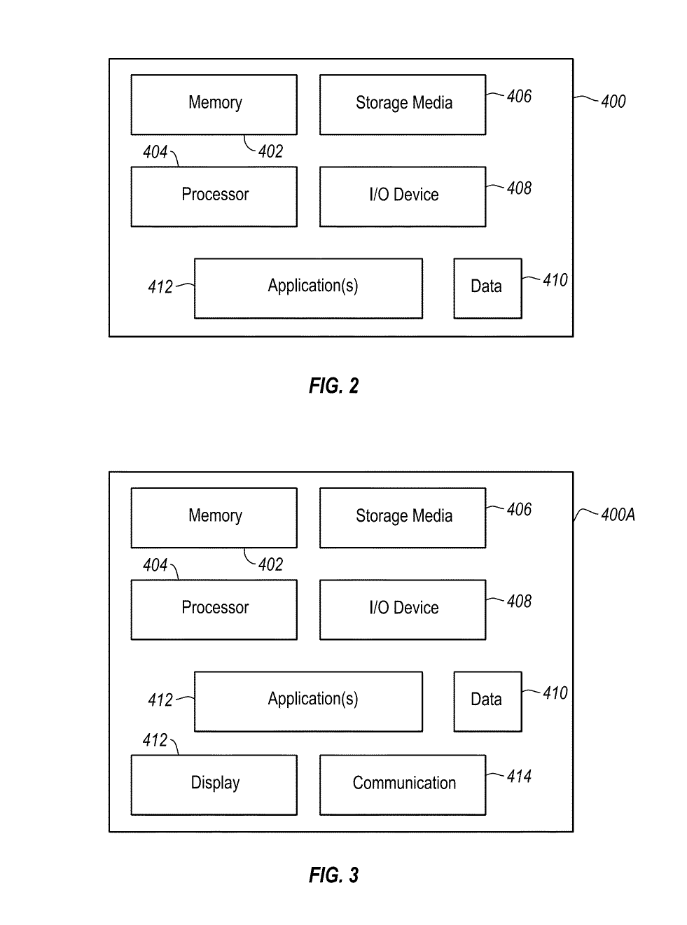

In general, a virtual machine can include a computing device that runs an operating system that can host other operating systems, or multiple copies of itself. As well, a virtual machine may comprise a representation of one or more hardware components that are associated with a plurality of different underlying computing devices. Such hardware components can include, for example, storage media, peripherals, processors, and any of the elements set forth in FIG. 2, discussed below. When presented to a user, for example, the virtual machine can appear as a single entity although it may actually operate using hardware of a plurality of different computing devices. In similar fashion, virtual operating environments and infrastructures can be defined and employed.

With more particular reference now to FIG. 1, details are provided concerning the example operating environment 100. As indicated there, the operating environment 100 may include one or more servers, such as server 200 for example. The server 200 may be an application server that hosts one or more applications 250, although the scope of the invention is not limited to any particular type, number, or implementation of servers.

The server 200 can communicate with a database 225, which may be located remotely from the server 200, although that is not required. As well, the server 200 may communicate with ‘n’ number of clients 300a, 300b and 300n, where ‘n’ can be any number that is 1 or greater.

Each of the clients 300 can comprise any of a variety of types of devices, examples of which include, but are not limited to, desktop computers, laptops, electronic tablets, smartphones, personal digital assistants (PDA), and portable digital media players. As noted elsewhere herein, one or more of the clients 300 may communicate wirelessly, or by hardwire or optical connection with the server 200, although the scope of the invention is not limited to any particular type or medium of communication. In some instances, the clients 300 may also communicate with each other.

In the example of FIG. 1, the application or applications 250 hosted by the server 200 include a research application 252 that cooperates with a research client 350 installed on one or more of the clients 300 to enable performance of the research methods, and/or portions thereof, disclosed herein. The research client 350 may be tailored in terms of its form and/or functionality to suit the particular device(s) or environment in which it is deployed. By way of example, the research client 350 may be Windows® or MAC-OS® based when installed on a PC or laptop. As another example, the research client 350 may take the form of an app (application) when installed on a device such as a smartphone or tablet. As such, at least some embodiments of the research client 350 are compatible with the Android® operating system, or the Apple iOS® operating system.

Where implemented in the form of an app, for example, embodiments of the invention may be configured to interoperate with other functions and elements of the device where the app is installed. By way of example, one embodiment of the app interfaces with the camera of a device, such as a smart phone for example, so that when the device is used to take a picture of a document, photo, grave marker, or other material, the picture can then be uploaded by the app to the server that hosts the research application.

Directing attention briefly now to FIG. 2, and with continued reference to FIG. 1, details are provided concerning aspects of an example computing device 400 such as may be employed in connection with one or more embodiments of the invention. The example computing device 400 may be a virtual device, or a physical device. Thus, the server 200 and/or one or more clients 300 may take the form of a computing device 400 and, accordingly, can include any one or more of the components, in any combination, of the example computing device 400. These components may be in addition to those disclosed in FIG. 1. Moreover, any or all of those components can be physical hardware, or may comprise virtual components.

As indicated in FIG. 2, the computing device 400 includes a memory 402 which may comprise RAM and/or ROM. Computer-executable instructions may be stored in the memory 402 and/or elsewhere in the computing device 400. The computing device 400 may also include one or more processors 404 which may be hardware processors operable to execute computer-executable instructions for performing various processes. As well, the computing device may include storage media 406, I/O device 408, and data storage 410. As well, one or more applications 412 may be provided that comprise executable instructions. One example of such an application 412 is a research client, examples of which are disclosed elsewhere herein.

In at least some instances, the example computing device 400 may comprise a host machine that hosts one or more applications. As such, the computing device 400 can be implemented, by way of example only, as a server (e.g., a file server, an email server), computer (e.g., desktop computers, laptop computers, tablet devices, smartphones), virtual machine, or any combination thereof. Each of the one or more computing devices 400 can be associated with its own data. As well, a computing device 400 may generally be any device that includes one or more applications which require communication with devices such as the server 200, client 300, and/or other devices. Thus, the computing device 400 may both receive communications from, and transmit communications to, one or more of the server 200, client 300, and/or other devices.

With attention briefly to FIG. 3, an example client device 400A is disclosed. In general, the client device 400A can include any combination of the elements of the computing device 400, and can additionally include a display 412, and a communications module 414 configured for wired, wireless, and/or optical communication with any one or more elements of the example operating environment 100, such as the server 200 for example.

As disclosed herein, various example UIs are discussed in connection with embodiments of the disclosed methods, and elements that are common to multiple UIs will be introduced and discussed only with respect to the first UI in which they appear with the understanding that, except as may be noted, the common elements perform and/or enable the same functions in all the UIs in which they appear.

It should be noted that with respect to the disclosed UIs, those UIs may be displayed at a client that may be remote from an application server. As noted earlier, the UIs may be displayed by a browser at the client, although that is not required and other display applications can alternatively be used. Thus, the UIs enable a user using the research client to transmit requests, commands, and other communications to the application server hosting the research application, which can then respond to these communications.

Moreover, while a variety of UIs are disclosed herein, it should be understood that any combination of the disclosed example UIs may be referred to generally as constituting a UI.

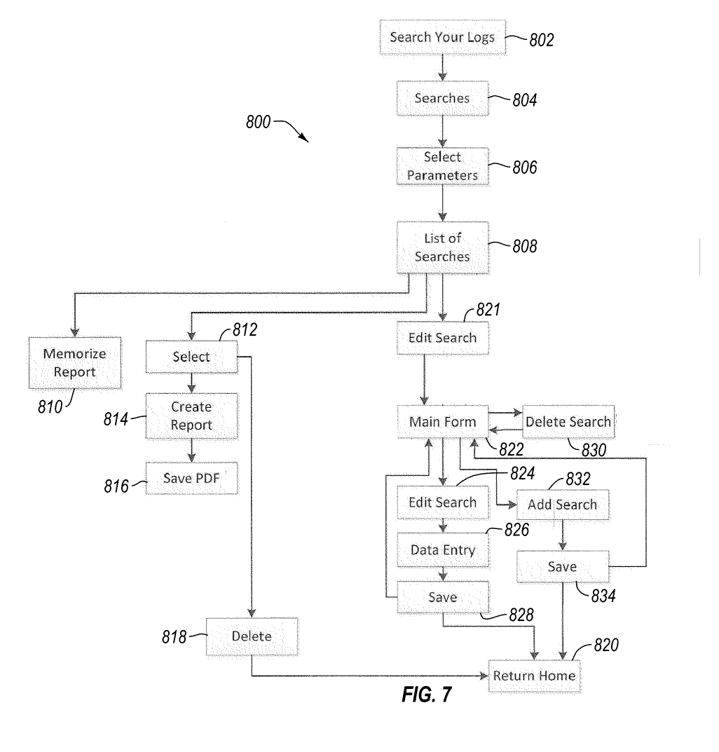

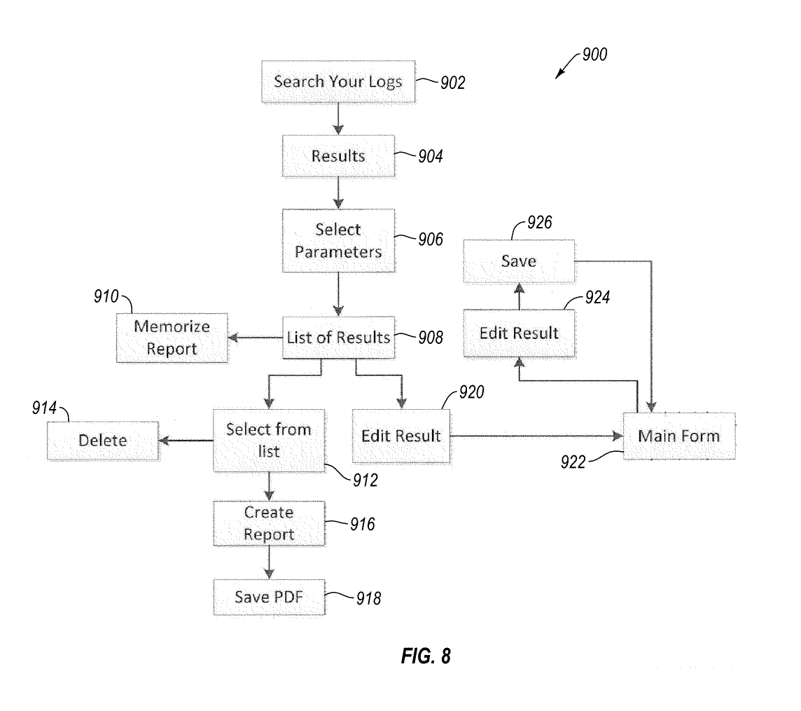

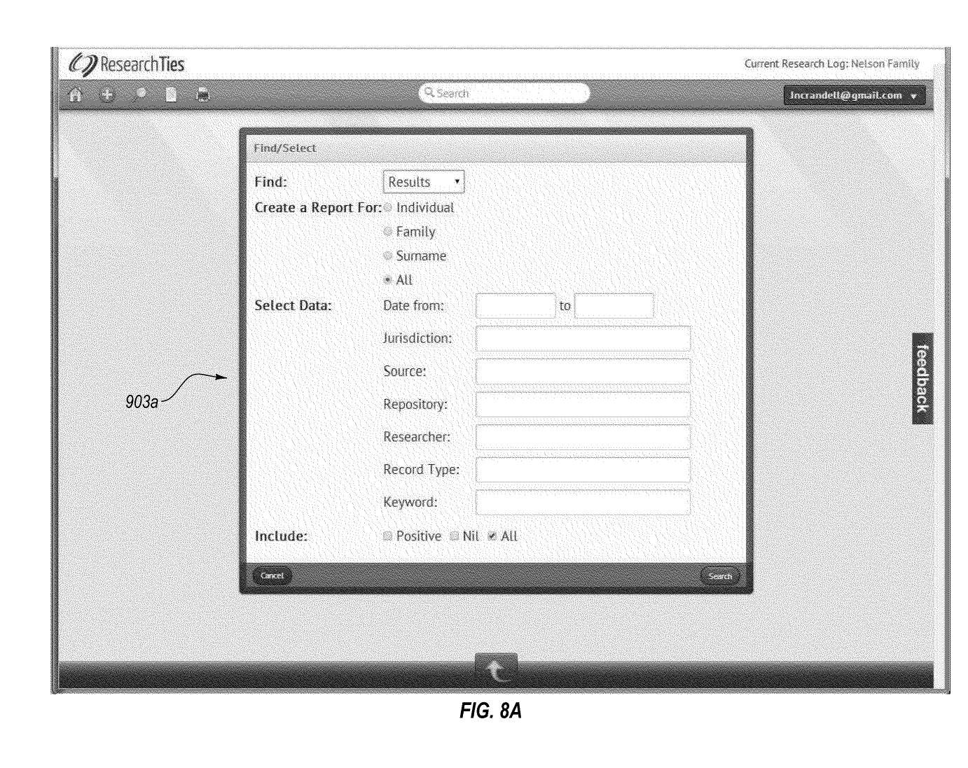

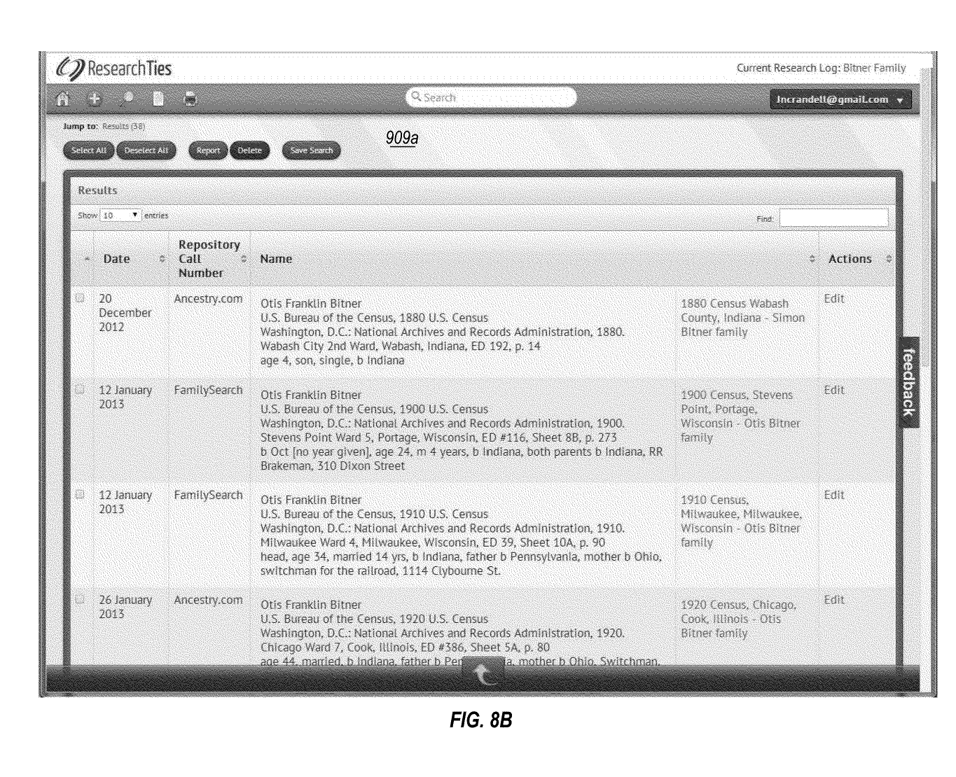

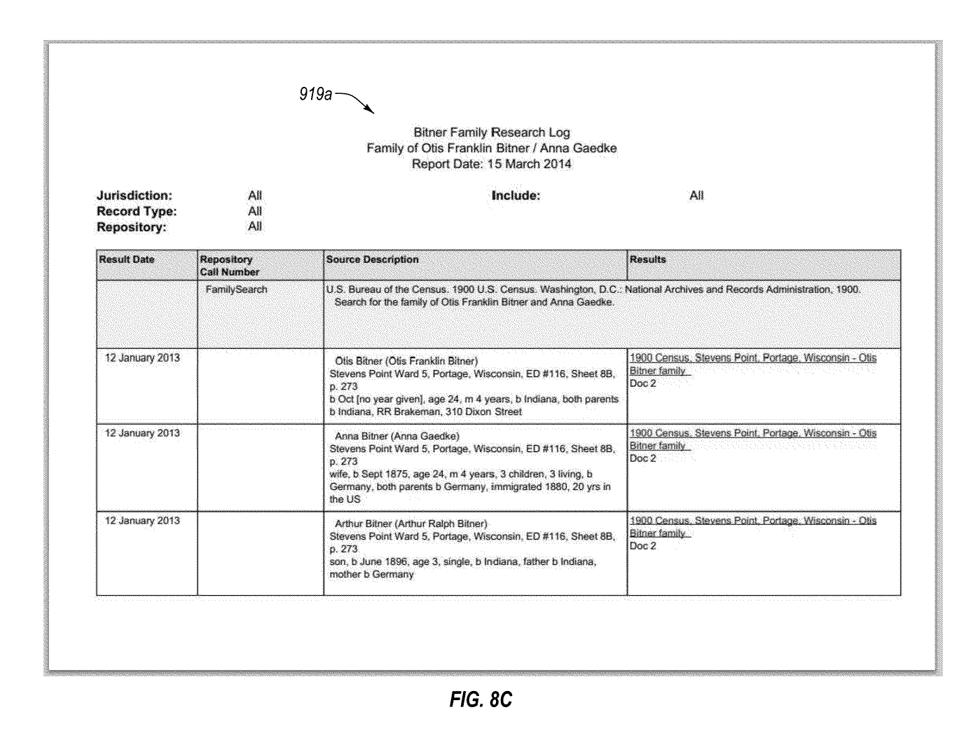

Finally, it should be noted that for the sake of clarity and brevity, functions common to two or more UIs are not necessarily displayed in each of the disclosed flow charts. For the purposes of illustration, the “main form” disclosed in the flow chart of FIG. 8 provides a portal not only to the functions disclosed in FIG. 8 and the associated UIs, but also to the functions disclosed in the flow chart of FIG. 7 and the associated UIs. To further illustrate this point, and with reference again to FIG. 8, the flow chart of FIG. 8 is primarily concerned with searching for results and, correspondingly, only the main form functions that are relevant to that process are displayed in FIG. 8 although, as noted, the main form provides a portal to other functions not displayed in FIG. 8 but which are displayed in other figures.

### C. SELECTING, FORMULATING AND ADDING TO AN OBJECTIVE

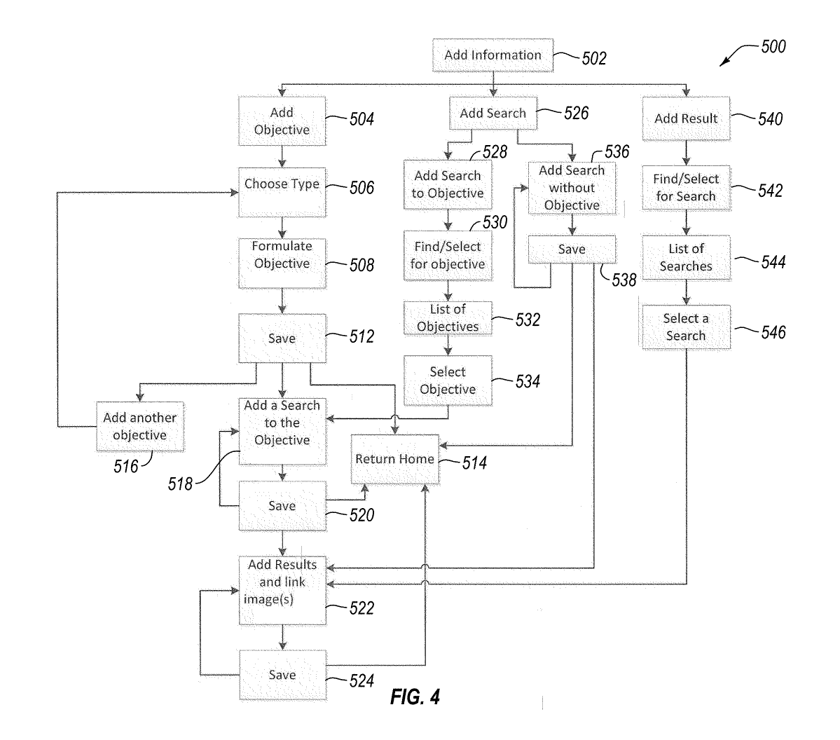

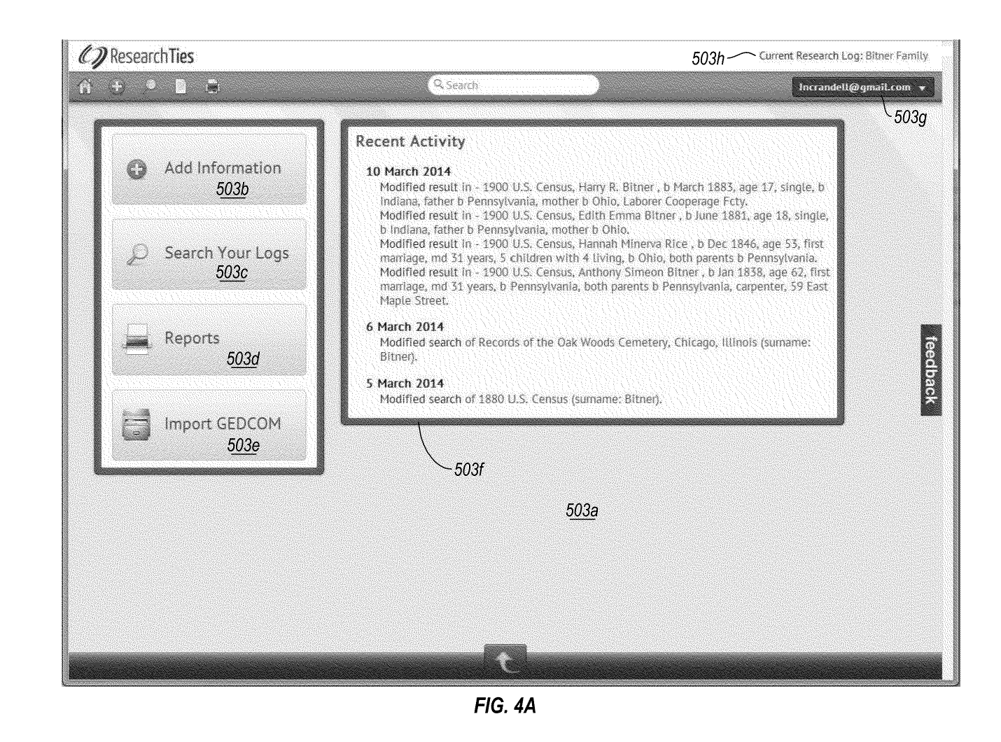

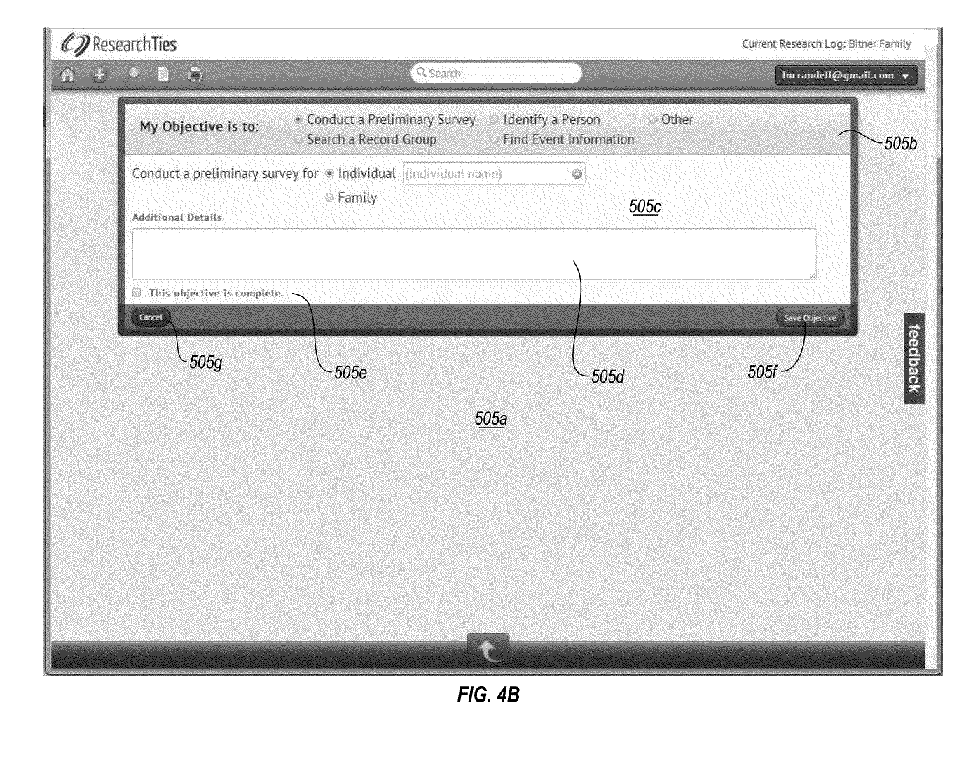

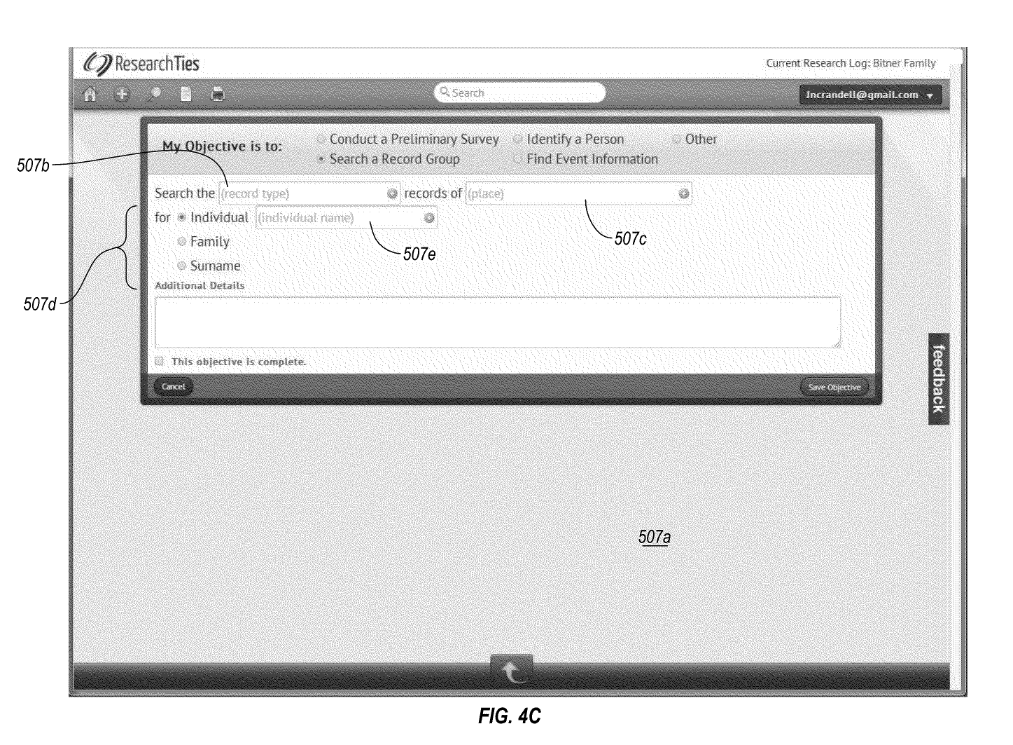

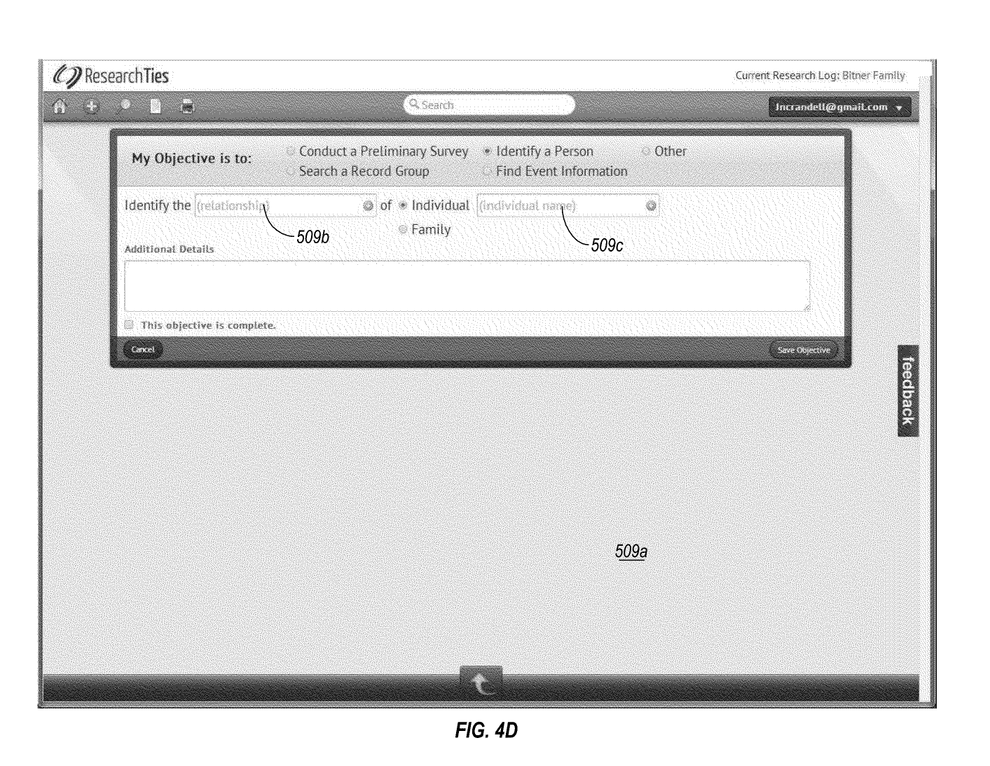

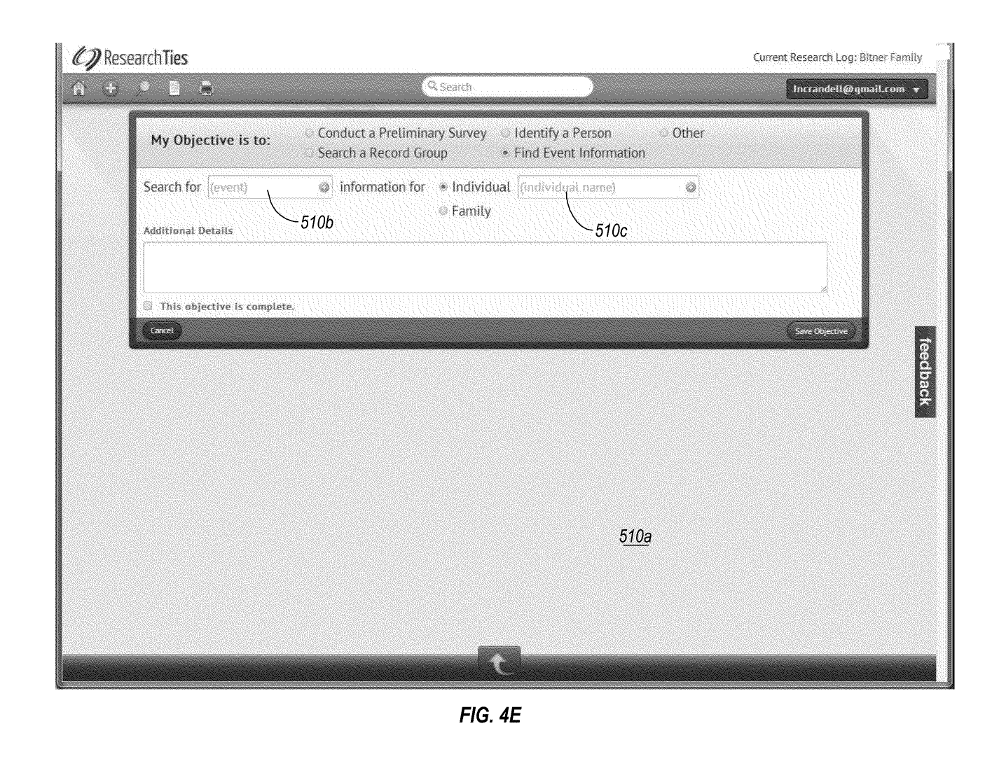

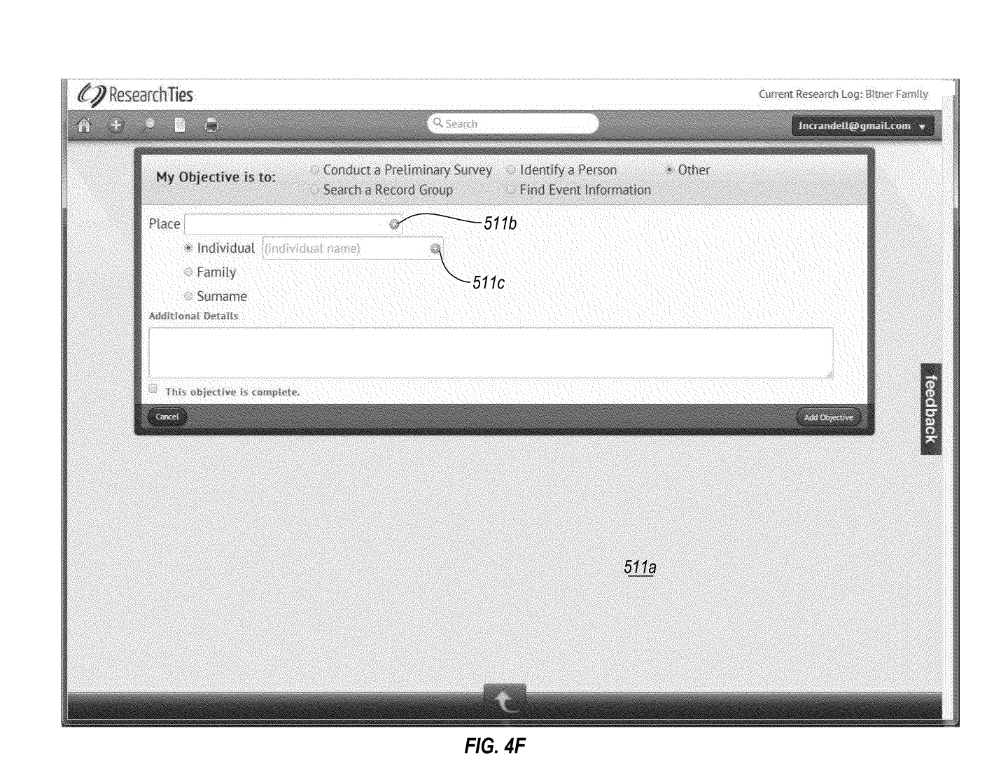

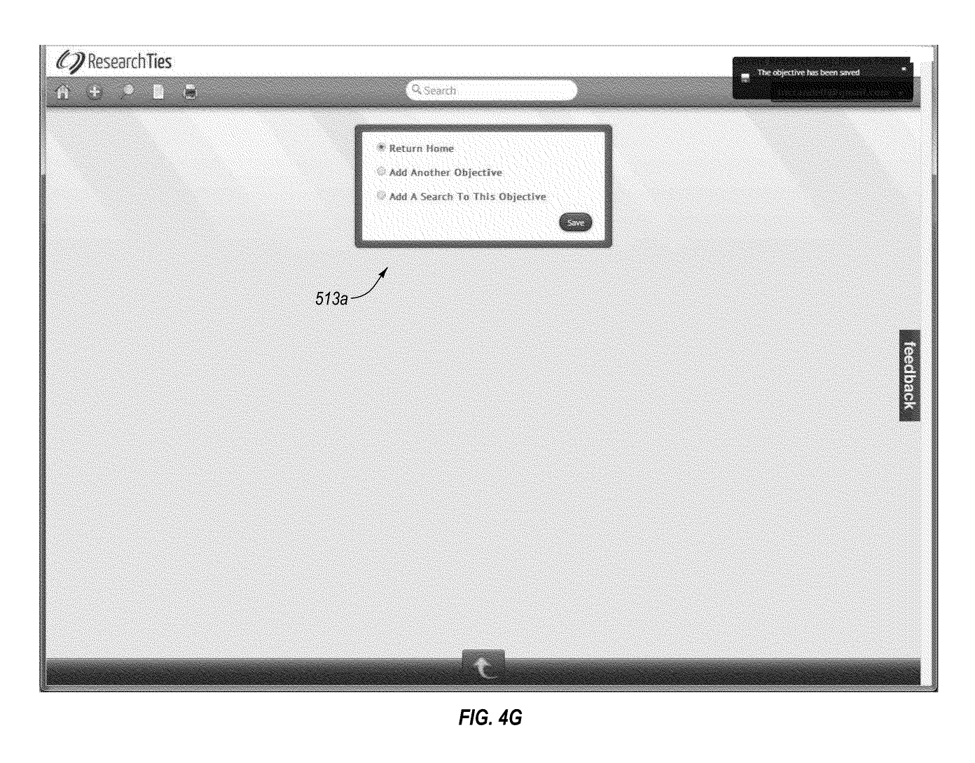

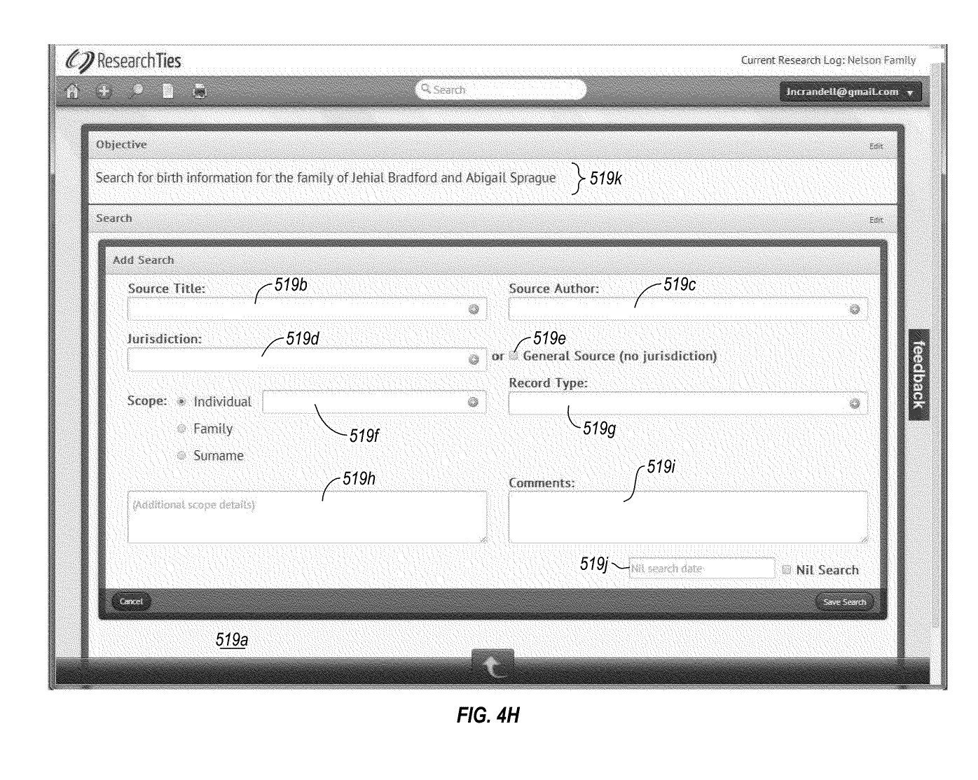

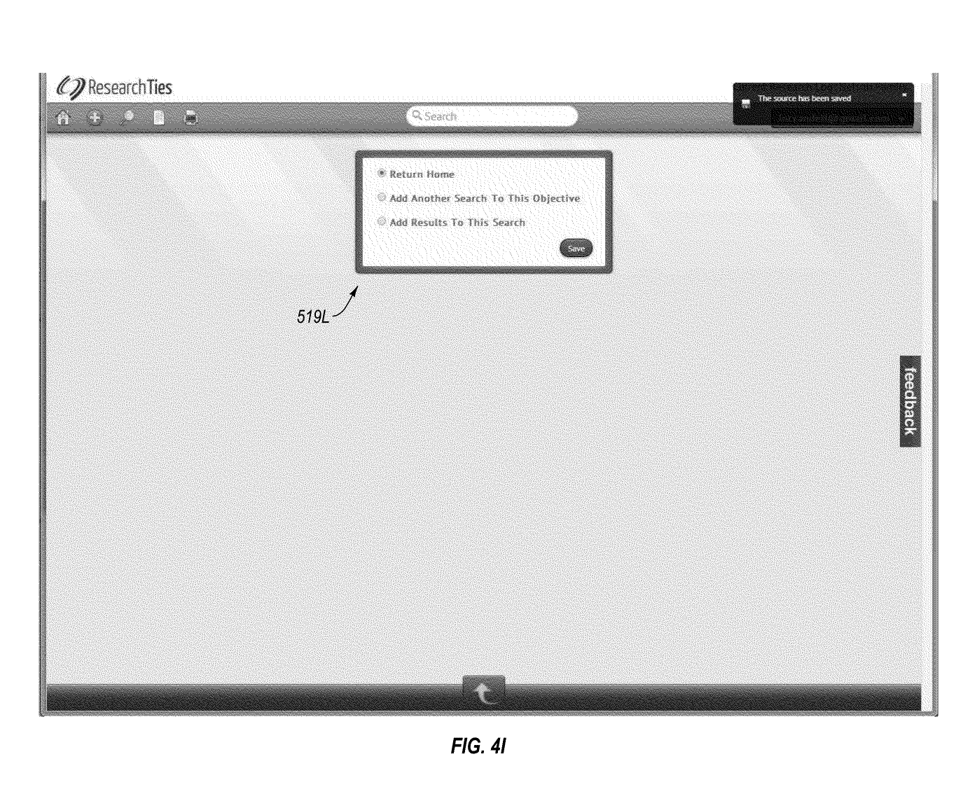

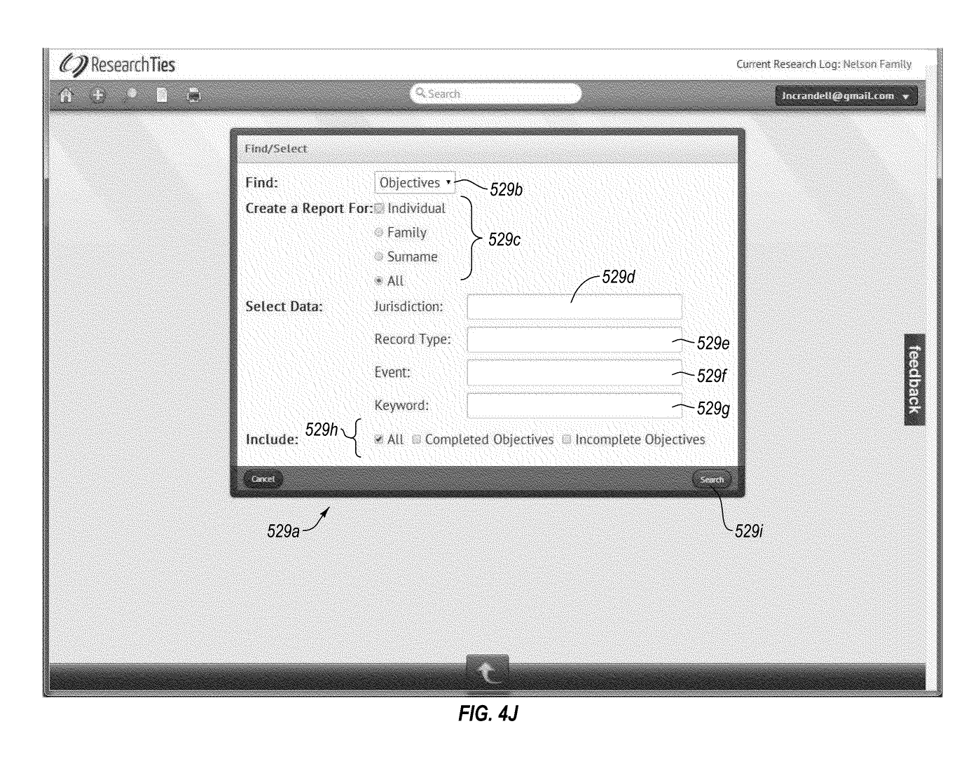

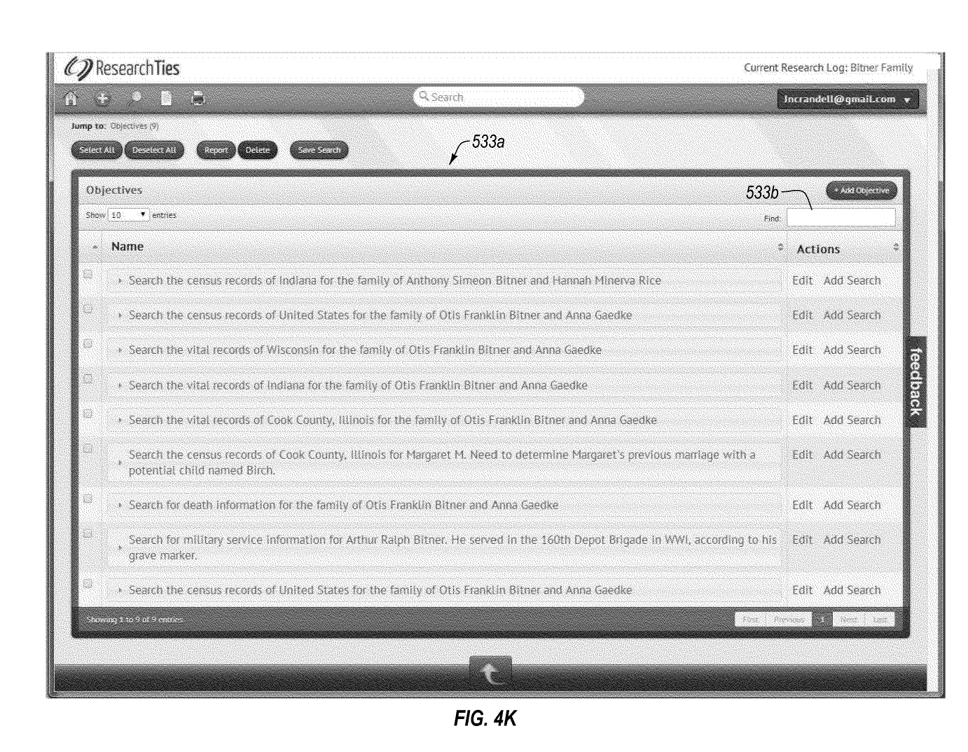

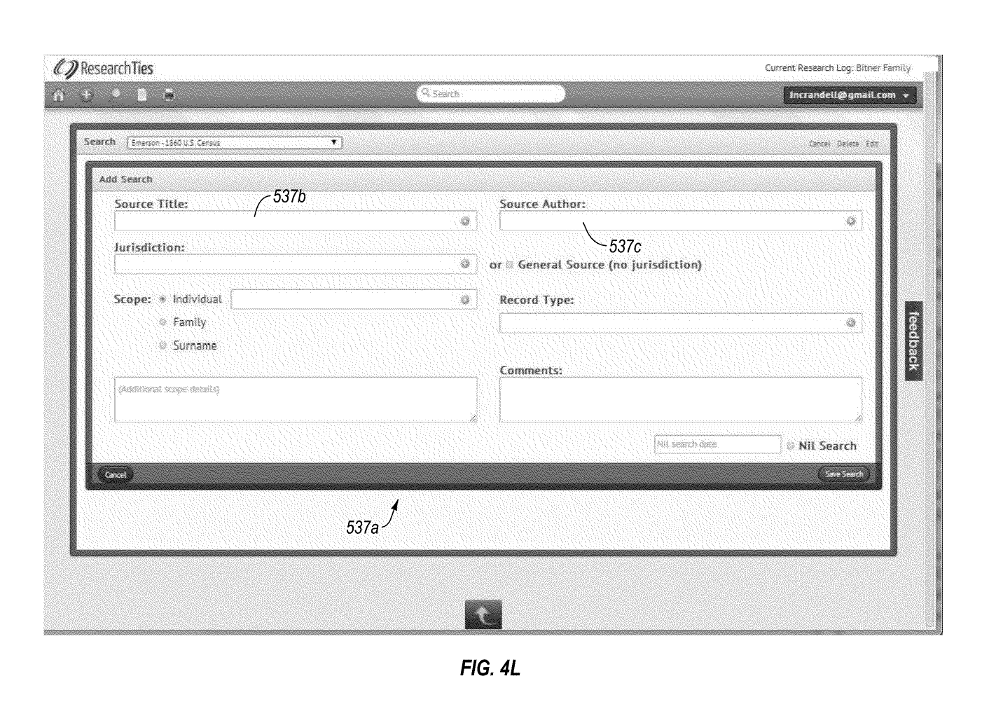

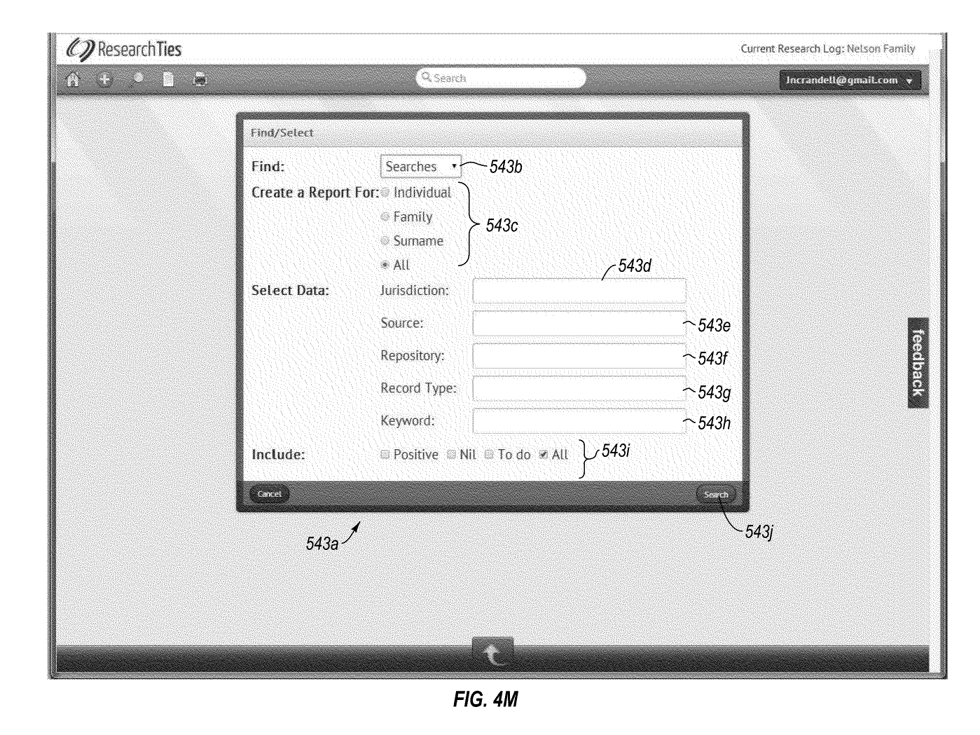

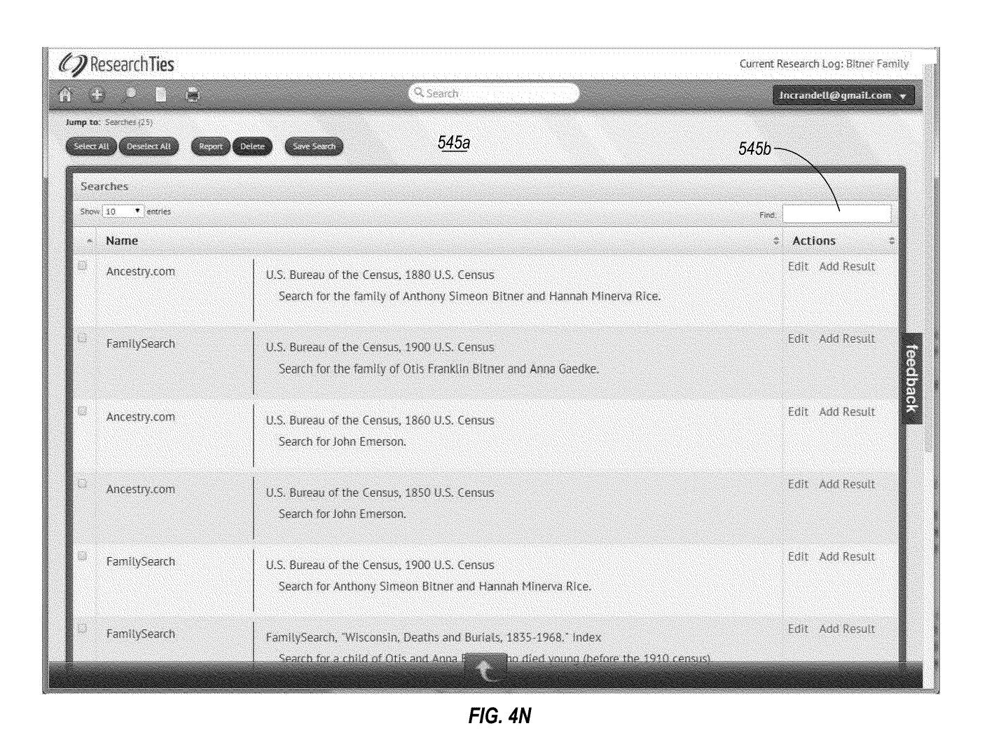

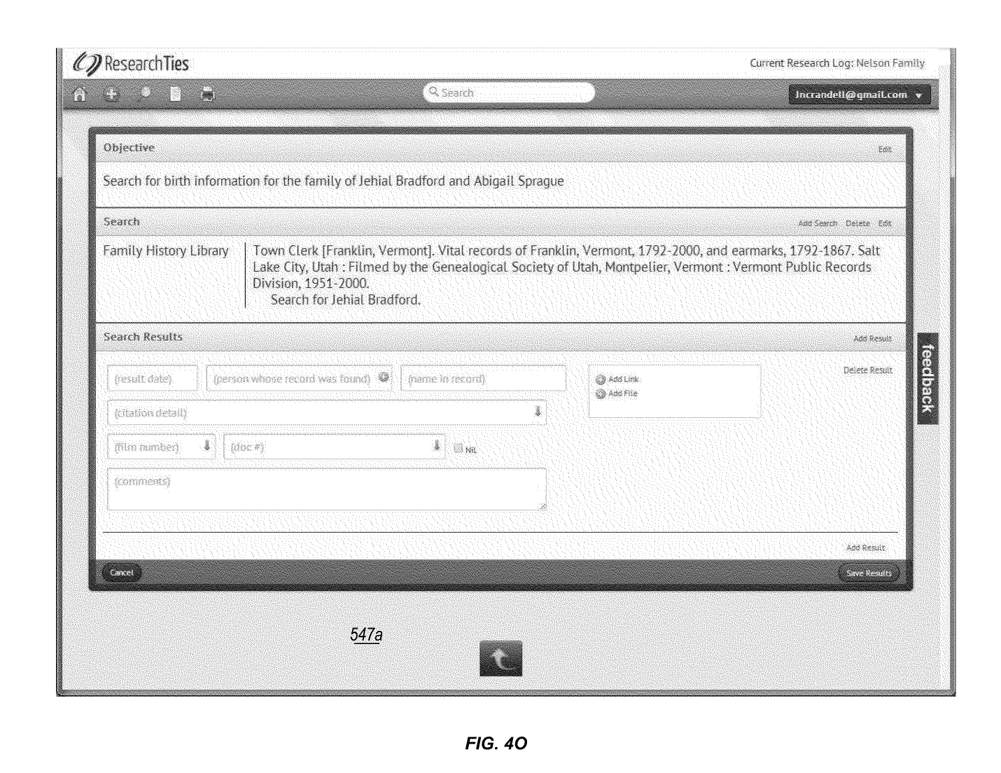

Directing attention now to FIGS. 4-4g, details are provided concerning an example method 500 for adding and/or refining information concerning one or more research objectives, searches, and/or search results. In general, an objective refers to a research goal that the user is attempting to achieve. Example objectives include, but are not limited to, conducting a preliminary survey of genealogical information, searching a record group that was previously defined, identifying a particular person, finding event information, conducting a locality survey for historical information, or performing any other task(s) that enable the user to achieve the research goal.

Correspondingly, a search can be defined and implemented to aid in the achievement of an objective, and the product of a search are the search results that are obtained based upon the search definition. The processes disclosed in FIG. 4 can be performed by a server, a client, or a combination of the two, and while various processes are set forth in a particular order, it should be understood that the scope of the invention is not limited to the illustrated order and the disclosed processes can be performed in other orders as well.

Moreover, it is not necessary that all of the processes disclosed in FIG. 4 be performed. For example, a user may choose to perform only the “add result” process if, for example, an objective has already been defined and a search performed. Thus, the processes of FIG. 4 can be performed in whole, in part, or in any combination with each other.

As well, it should be noted that the foregoing points, while addressed to FIGS. 4-4o, apply as well to all other process and method figures in this application.

Turning now to FIG. 4, the method 500 can begin when a user decides to add 502 information to a research log. To this end, a user may employ the example UI 503a of FIG. 4a to add information, and a button 503b can be provided to enable a user to start the “add” process. Additional buttons 503c through 503e can be provided that enable a user to search existing logs, define and generate reports, and import a GEDCOM file, respectively. As well, the UI 503a may display 503f a list of recent activity by the user, whose email address or other identifier 503g can be displayed on the UI 503a. 503g can also be a dropdown menu providing basic functions such as, but not limited to: changing to a different log in the user's account, opening a Learning Center, updating account information, and logging out. Finally, the UI 503a may display the name or other identifier 503h of the research log, the “Bitner Family” research log in the illustrated example, that is currently being accessed. As with the case of other UIs disclosed herein, the UI 503a can be displayed using a web browser, window, or any other suitable mechanism.

After the user has selected 502 the “add information” button, a drop down menu is presented that enables the user to select various options including, “add objective.” Other add options, such as “add search” and “add result,” are discussed below. Upon selection 504 of the “add objective” option, and as shown in FIG. 4b, the user is presented with a UI 505b that enables a user to select 506 the type of objective to be added.

For example, the UI 505a includes an objective ribbon 505b that enables a user to select 506, for example, from among: a) Conduct a Preliminary Survey, b) Search a Record Group, c) Identify a Person, d) Find Event Information, or e) Other. In the particular example of FIG. 4b, the “Conduct a Preliminary Survey” objective type has been selected 506. After the user has selected an objective type, the user can then formulate 508 the objective.

For example, if the user selects 506 the “Conduct a Preliminary Survey” option, the user can use input element 505c to define whether the survey will be conducted for an individual, whose name can be selected from the dropdown or added with the add circle in that field, or a family, whose name can be selected from the dropdown or added to the UI with the add circle in that field. If the user adds a family, the user may also have the option to add a new place for the marriage place and/or a new individual for the husband and/or wife. As well, the UI 505a includes an “Additional Details” box 505d where a user can enter information or comments concerning the newly-created objective. A checkbox 505e or other input element can later be marked by the user to indicate that the objective has been completed.

After formulating the desired objective, the user can select the “Save Objective” button 505f. Finally, if a user should decide not to continue with the writing of any objective, the user can simply select the “Cancel” button 505g.

If the user selects 506, “Search a Record Group” as the desired objective type, the user is presented with the UI 507a shown in FIG. 4c. The UI 507a includes an input element 507b that enables a user to select or add a new record type, and an input element 507c that enables a user to select or add a place associated with the record type. As further indicated in FIG. 4c, the UI 507a also includes a series of radio buttons 507d that enable a user to specify whether the scope of the search will be for an individual, family, or surname. Selection of any of these choices, such as “individual” in the example of FIG. 4c, causes the presentation of an associated input element 507e that enables a user to select or add a name to be associated with the selected button. Moreover, embodiments of the invention provide flexibility that can be useful to the researcher. By way of illustration, where a new “surname” is added, alternate spellings of the name can also be entered.

Turning now to FIG. 4d, the UI 509a is presented to a user when the user selects 506 “Identify a Person” as the desired objective. For this type of objective, an input element 509b is provided that enables the user to input a relationship of an individual or family specified using input element 509c. In particular, where the objective is to “Identify a Person,” the user can add a new relationship and/or a new individual or family. If adding a new family, the user may also have the option to add a new place for the marriage place, and/or a new individual for the husband and/or wife of that family.

As indicated in FIG. 4e, the UI 510a is presented to a user when the user selects 506 “Find Event Information” as the desired objective. For this type of objective, an input element 510b is provided that enables the user to set the goal to search for event information relating to an individual or family, whose name can be specified using input element 510c. Thus, the user can add a new event and/or a new individual or family for an event. If adding a new family, the user has the option to add a new place for the marriage place and/or new individual for the husband and/or wife of the family.

Turning now to FIG. 4f, the UI 511a is presented to a user when the user selects 506 “Other” as the desired objective. For this type of objective, an input element 511a is provided that enables the user to input any information useful in formulating an objective. For example, the user can input a place name 511b, and/or specify, using input element 511c, an individual, family, or surname. If adding a new family, the user has the option to add a new place for the marriage place and/or new individual for the husband and/or wife. When adding a new surname, alternate spellings of the surname can be entered.

After the objective has been formulated, using one or more of the UIs 505a, 507a, 509a, 510a, and 511a, the user can then save 512 the formulated objective and return home 514, e.g., to a home page. The save process can be initiated by way of the UI 513a shown in FIG. 4g. In addition, or as an alternative to the return home 514, the user can decide to select and formulate 516 another objective. The UI 513a also enables a user to add a search 518 to the objective.

In particular, once the objective has been formulated, and saved 512, the user can then add 518 a search to that objective. To this end, UI 519a of FIG. 4h enables a user to enter information identifying the search that is to be added to the objective. The data selected for the saved objective can be concatenated into a full sentence 519k and shown at the top of UI 519a. The search to be added can be an existing search, or can be defined as part of the add process.

For example, the UI 519a can include input elements 519b, 519c and 519d which enable a user to select or add information such as one or more of “source title,” “source author,” and “jurisdiction,” respectively. Where the jurisdiction is not known, or will not be specified, an input element 519e for “general source” can be checked. When a new source is being added, a new repository can be added. Other input elements 519f and 519g enable a user to select or add one or more of the scope of the search, and the record type, respectively. Where a new surname is added, alternate spellings of the surname can be recorded.

In addition to the aforementioned fields, the UI 519a may include input elements 519h, 519i, and 519j which respectively enable a user to enter additional scope details concerning the search to be added to the objective, comments concerning that search, and the option to identify and record a nil search date. Once the search to be added has been defined, the search can be saved 520. Whether the search already existed, or was newly defined, it can in either case be added 518 to the objective, as noted above. Further details concerning methods that can additionally, or alternatively, be used for adding a search are disclosed elsewhere herein.

After the search has been added and/or saved, the method 500 can return home 514, as shown in the example UI 519l of FIG. 4i. At this stage, the user can also add another search to the objective, or add results to the search that has been added to the objective.

For example, the user may wish to add 522 results and/or link images, documents and/or other materials to the search. Once the results and other materials are added 522, those can be saved 524. At this point, the method can either return to 522 or return home 514. Further information concerning an example UI for adding results to a search/objective is disclosed elsewhere herein.

With continued reference to FIG. 4, and directing attention now to FIGS. 4j and 4k, a user may, in addition or as an alternative to adding an objective, add 526 a search to the objective. This process may begin at 502 from the add information (see FIG. 4a) portion of the home page. At the add information stage, the user can add 526 a search. More particularly, the user can add a search to an objective, or add a search without an objective. If the former, the process moves to 528 where the user initiates a process to add a search to an objective.

In order to add a search to the objective, the user must find/select 530 the objective to which the search will be added. This may be accomplished, for example, through the use of a UI such as UI 529a disclosed in FIG. 4j. The UI 529a includes an input element 529b that enables a user to specify that it is an objective that is the focus of the find/select process. The user can also specify, using radio buttons 529c, whether the sought-after objective list is to be limited to an individual, family, or surname, or if objectives for all people should be returned. The UI 529a includes additional input elements 529d-g, respectively, that enable a user to specify the jurisdiction, record type, event, and/or keyword that should be considered in the find/select process. As well, the user can specify, using input element 529h, that all objectives, only complete objectives, or only incomplete objectives be returned as a result of the find/select process. Once the find criteria have been defined, or at any time prior, the user can cancel the definition process, or select the search button 529i to cause execution of the find process. As a result of the execution of the find process, a list of objectives matching the input criteria can be displayed 532, as indicated in the example UI 533a of FIG. 4k. The user can then select one or more of the listed objectives by selecting “Add Search.” As indicated in the UI 533a, the user can select/deselect any one or more of the listed objectives. The user can also generate a report based on one or more of those objectives, delete one or more objectives from the list, and save the find/select search results. The user can also add a new objective to the list, if desired. A search window 533b enables the user to search within the listed results for a search term or string. Finally, the user can sorts/elect one or more items from the list of results displayed by UI 533a by using the “first/previous” and “next/last” navigation buttons.

In any event, search(es) can then be added 518 to the objective, as discussed elsewhere herein. The process may, optionally, continue on from 518 as discussed earlier.

As noted above, a user may desire to add 536 a search without an objective. This can be accomplished, for example, by the use of a UI, such as UI 537a disclosed in FIG. 4l. In addition to input elements included in other example UIs disclosed herein, and not specifically addressed here with regard to FIG. 4l, the UI 537a also includes an input element 537b that enables a user to specify or select the title of a source, and an input element 537c that enables a user to specify or select the author of that source. The search can then be saved 538, and the process can advance to 514, 522 or 536, discussed elsewhere herein.

With continued reference to FIG. 4, and directing attention now to FIGS. 4m, 4n, and 4o, a user may, in addition or as an alternative to adding an objective, and adding a search to the objective, add results to a search. This process may begin at 502 from the add information (see FIG. 4a) portion of the home page. At the add information stage, the user can add 540 the results of a search.

In order to add results to a search, the user must first conduct a find/select process 542 to identify the desired search. This can be accomplished, for example, through the use of a UI such as UI 543a disclosed in FIG. 4m.

The UI 543a includes an input element 543b that enables a user to specify that searches are the focus of the find/select process. The user can also specify, using radio buttons 543c, whether the sought-after searches relate to an individual, family, surname, or all people in the database. The UI 543a includes additional input elements 543d-h, respectively, that enable a user to specify the jurisdiction, source, repository, record type and/or keyword that should be considered in the find/select process. As well, the user can specify, using input element 543i, that positive, nil, to do, or all, searches be returned as a result of the find/select process.

Once the find criteria have been defined, or at any time prior, the user can cancel the definition process, or select the search button 543j to cause execution of the find process. As a result of the execution of the find process, a list of search results matching the input criteria can be displayed 544, as indicated in the example UI 545a of FIG. 4n. The user can then select one of the listed searches by selecting “Add Result.” As indicated in the UI 545a, the user can select/deselect any one or more of the listed searches. The user can also generate a report based on one or more of those results, delete one or more results from the list, and save the find/select search results. A search window 545b enables the user to search within the listed results for a search term or string, and finally, the user can sorts/elect one or more items from the list of results displayed by UI 545a by using the “first/previous” and “next/last” navigation buttons.

After the list of searches has been displayed 544, the user can then select 546 a search from the list, by selecting “Add Results” for example, to add results to an identified search. This can be accomplished, for example, through the use of a UI such as the UI 547a disclosed in FIG. 4o. As indicated in FIG. 4o, the objective is displayed, as well as the name of the source and the nature of the search to which the results are to be added. Both the objective and the name/nature of the search can be edited through the UI 547a, and additionally, the displayed search can be deleted and/or one or more searches can be added to the objective.

As indicated by the UI 547a, the results to be recorded can include information such as, but not limited to, any one or more of result date, person or persons whose record(s) were found, the name(s) in those records, citation information, a film, frame and/or reel number, a document number, and any comments relevant to the results of the search. As well, the user can append the results with materials such as document and web page links, and various types of files including graphics files, word processing files, spreadsheets, and any other type of files. The results and appended information can then be saved 524. It should be noted that when adding a result to a search, one or more new individuals can be added to the database as well.

### D. CREATING AND MODIFYING LISTS

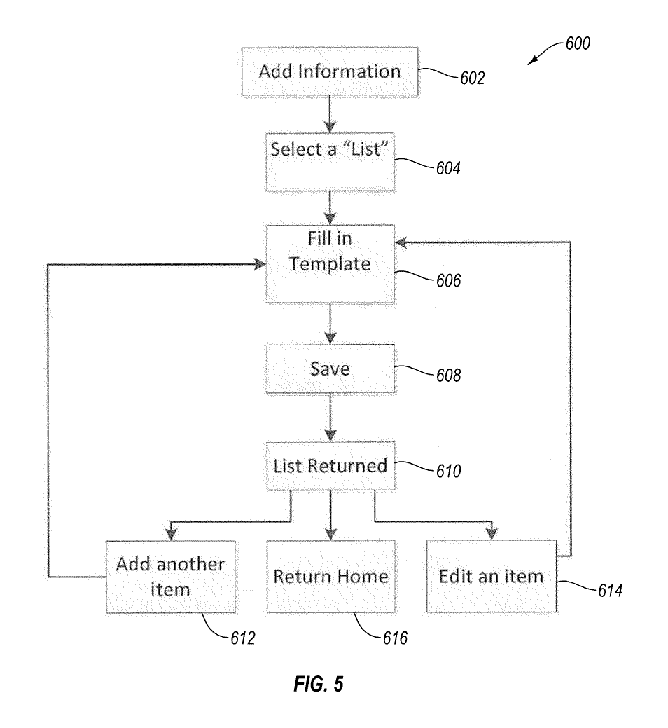

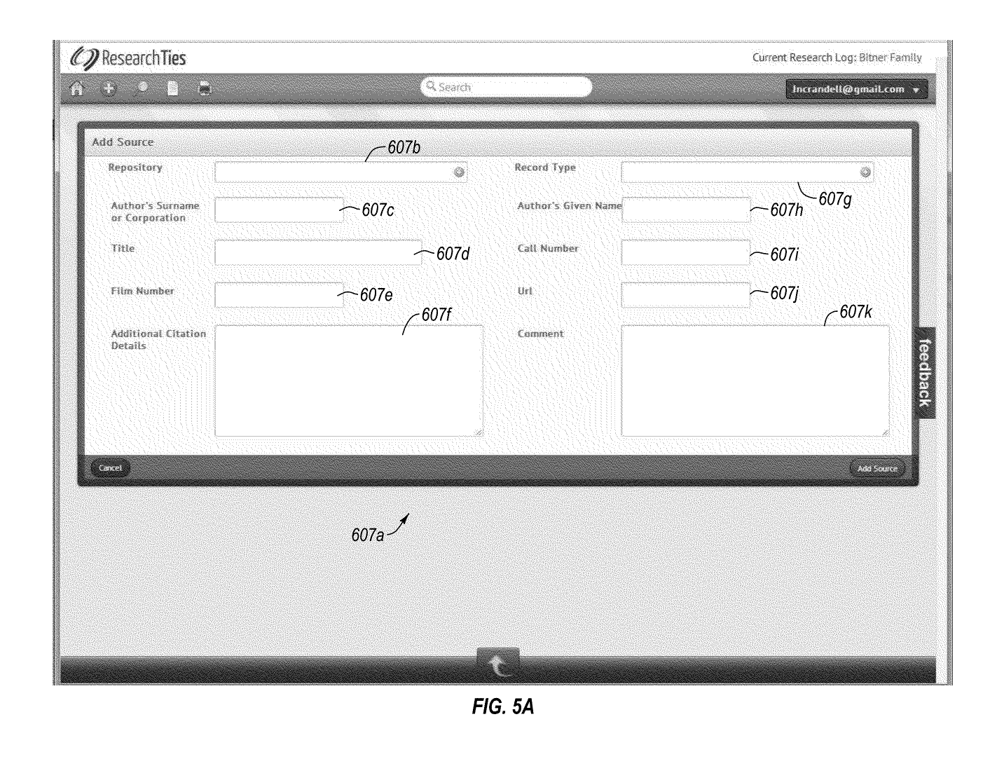

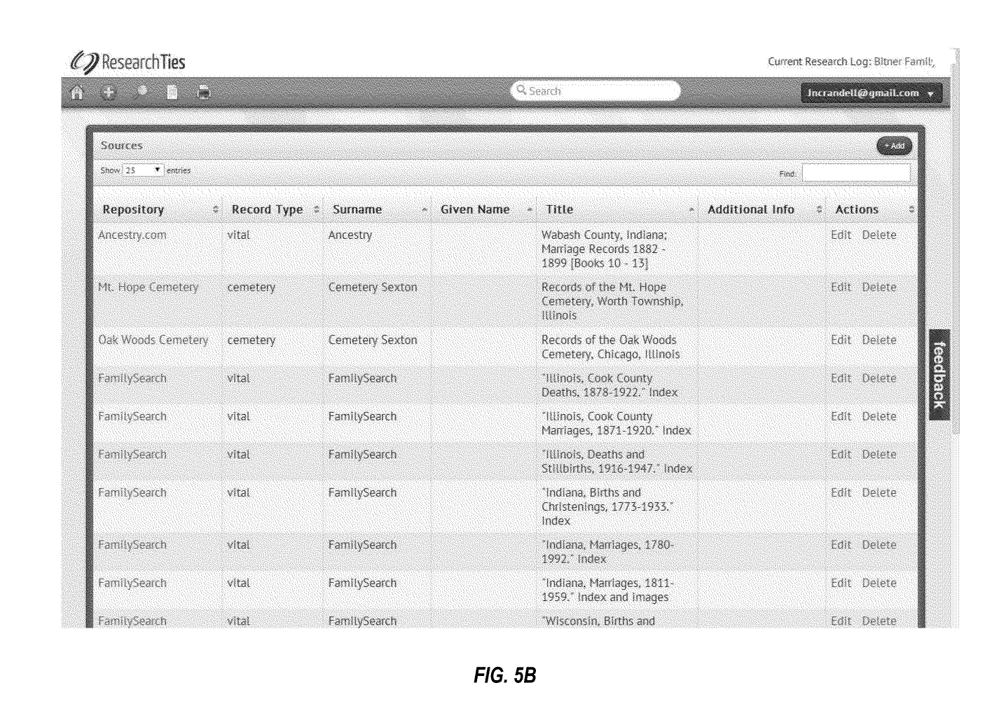

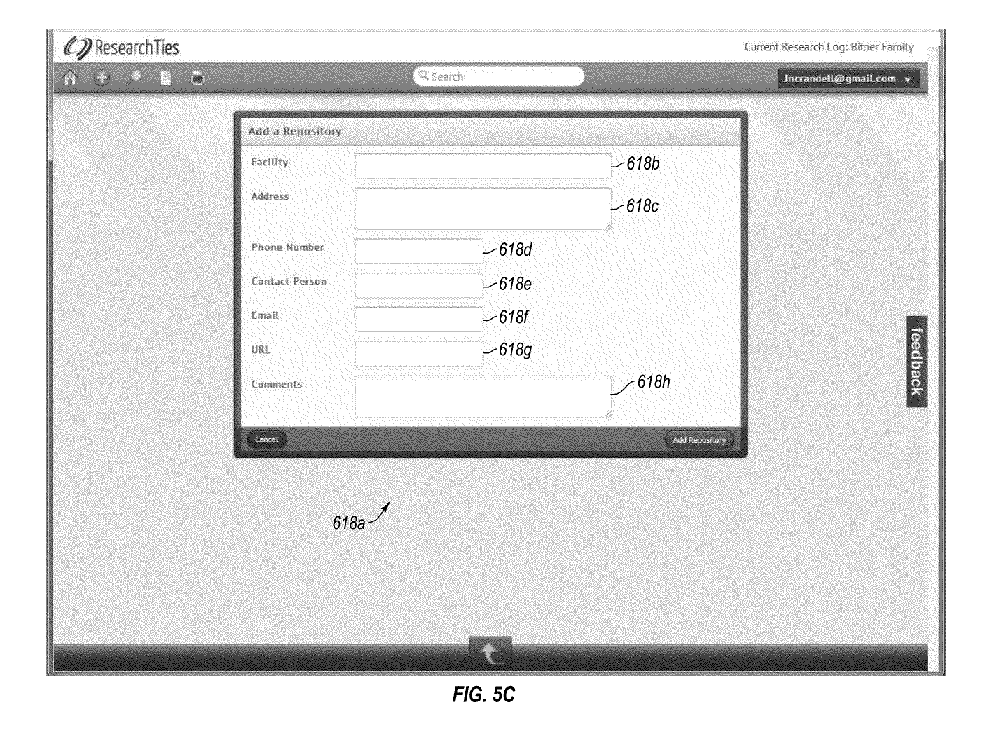

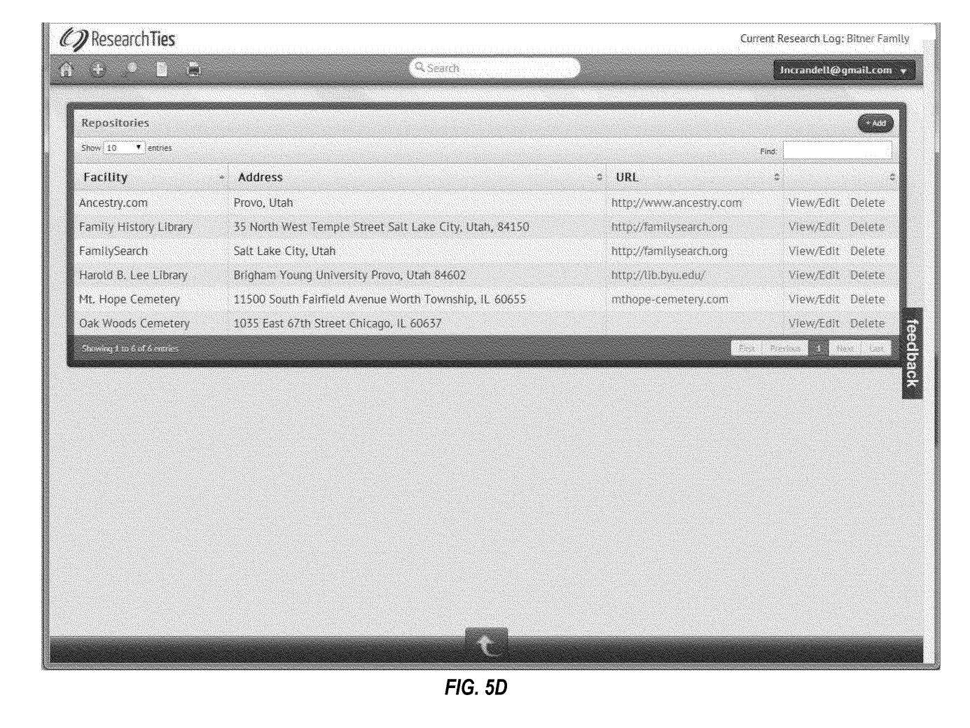

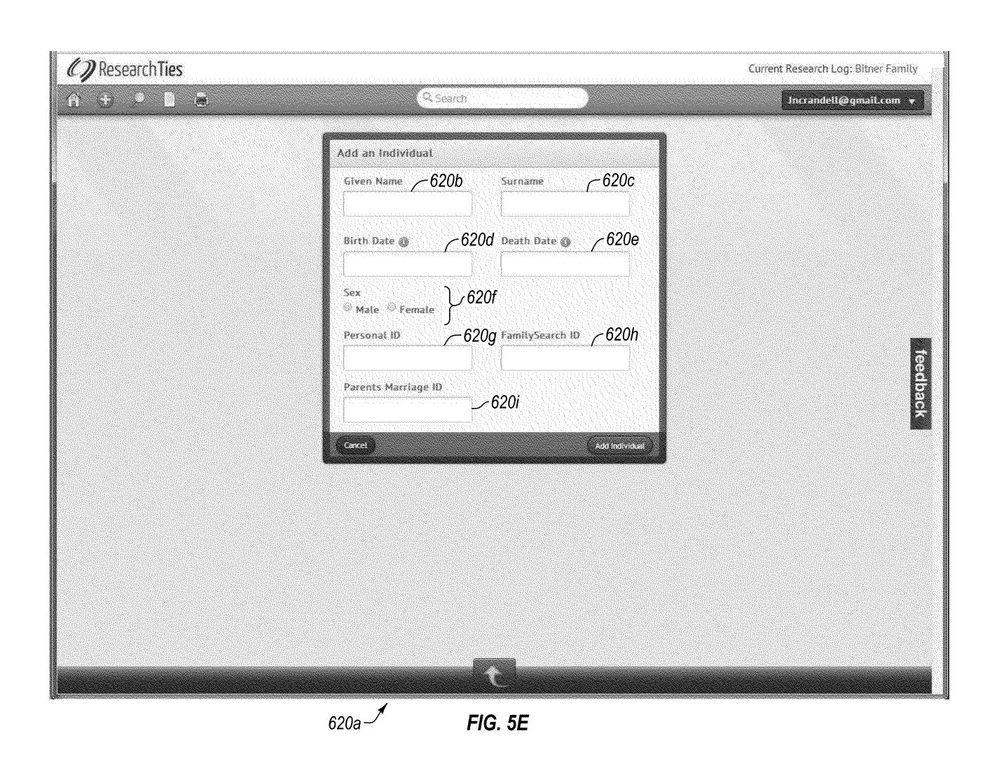

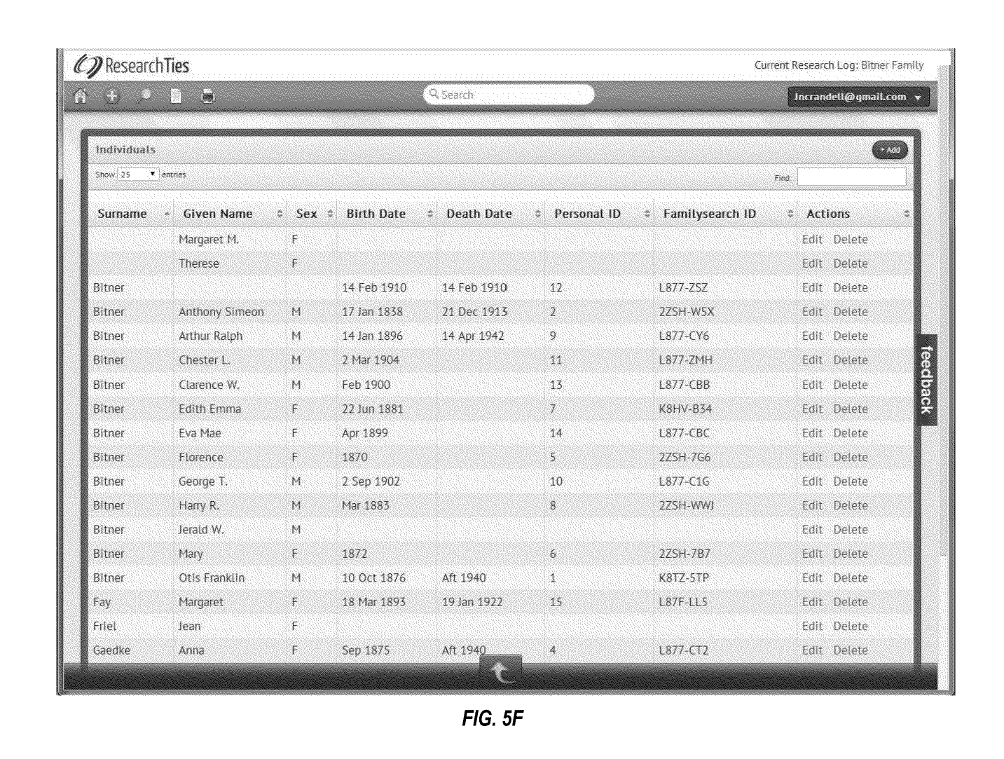

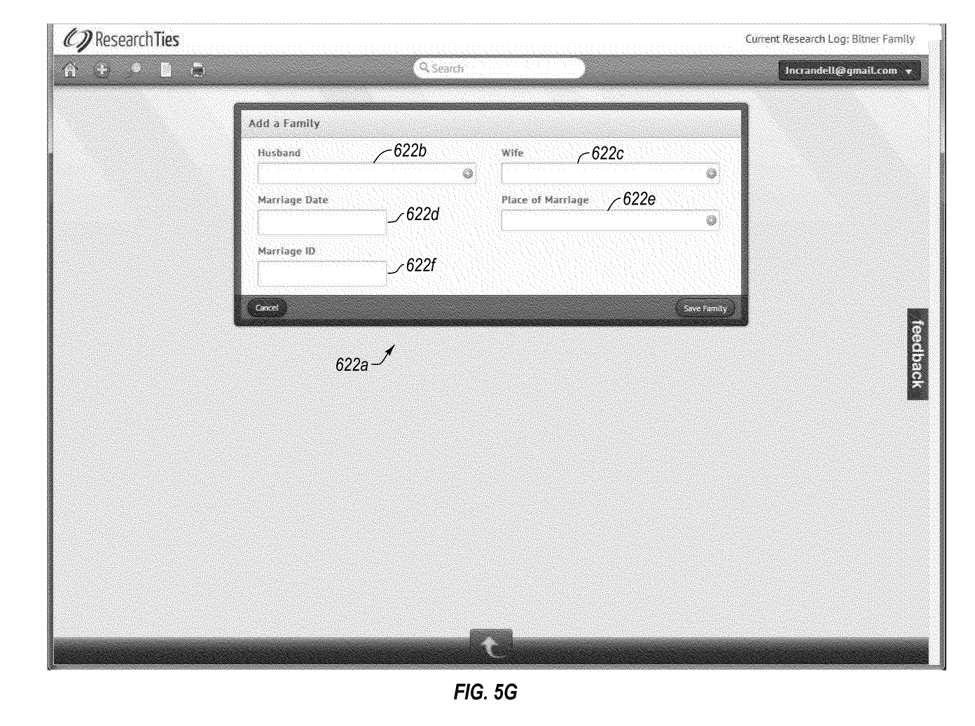

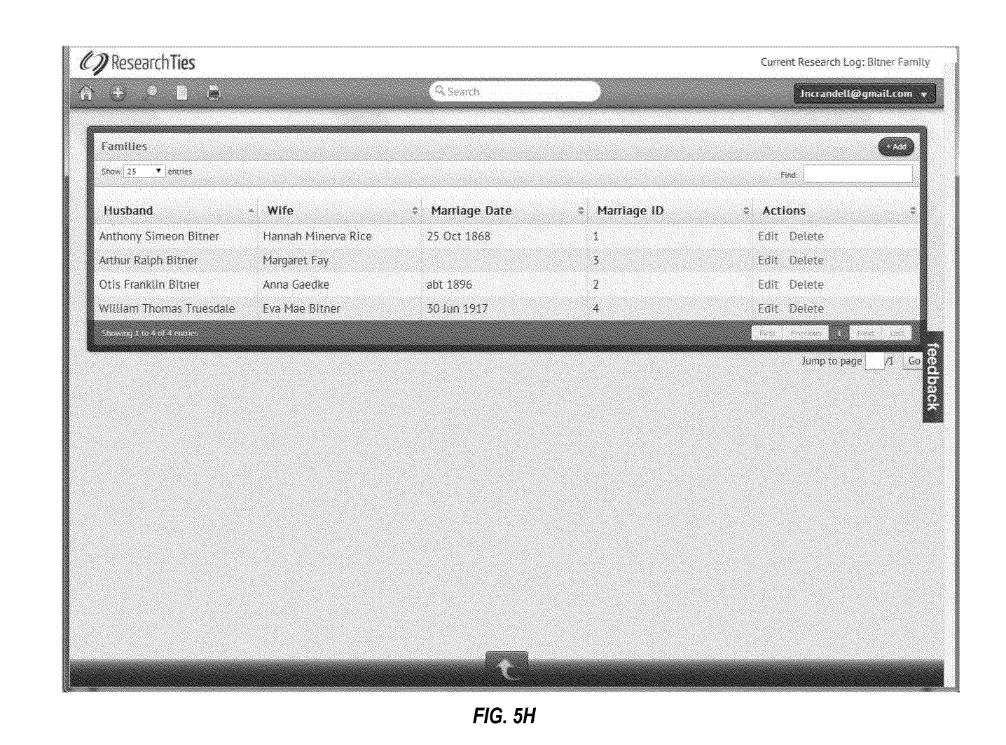

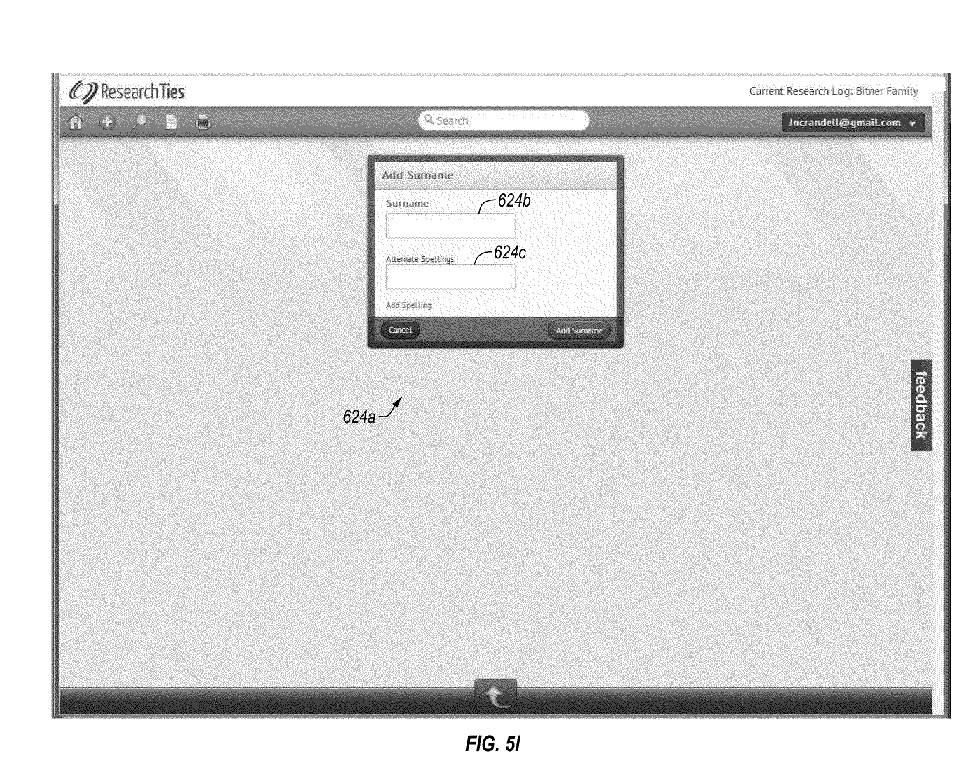

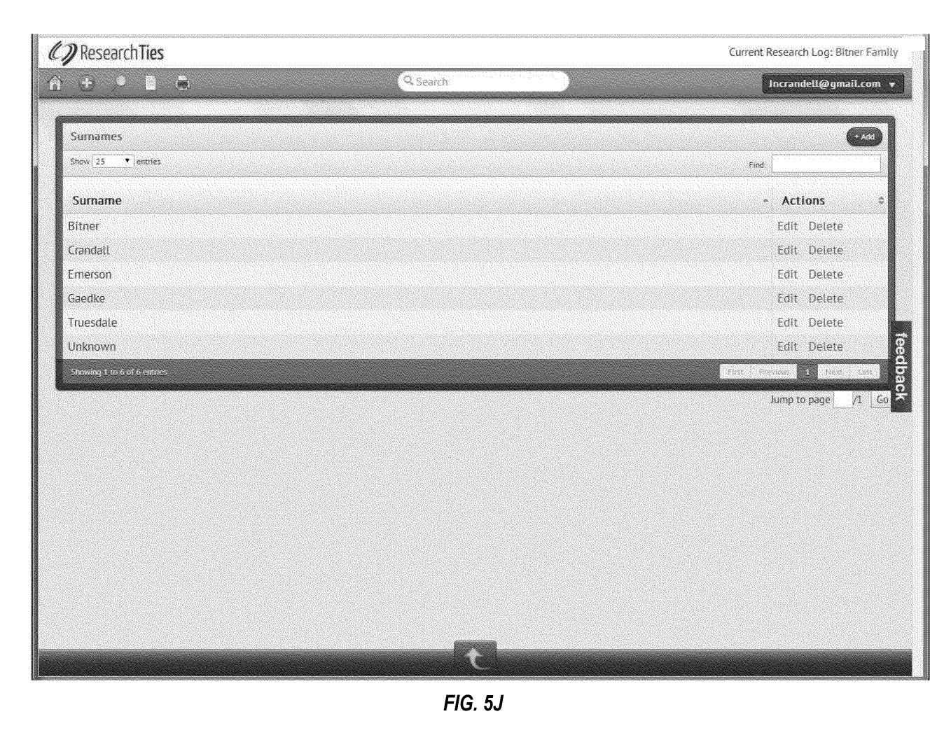

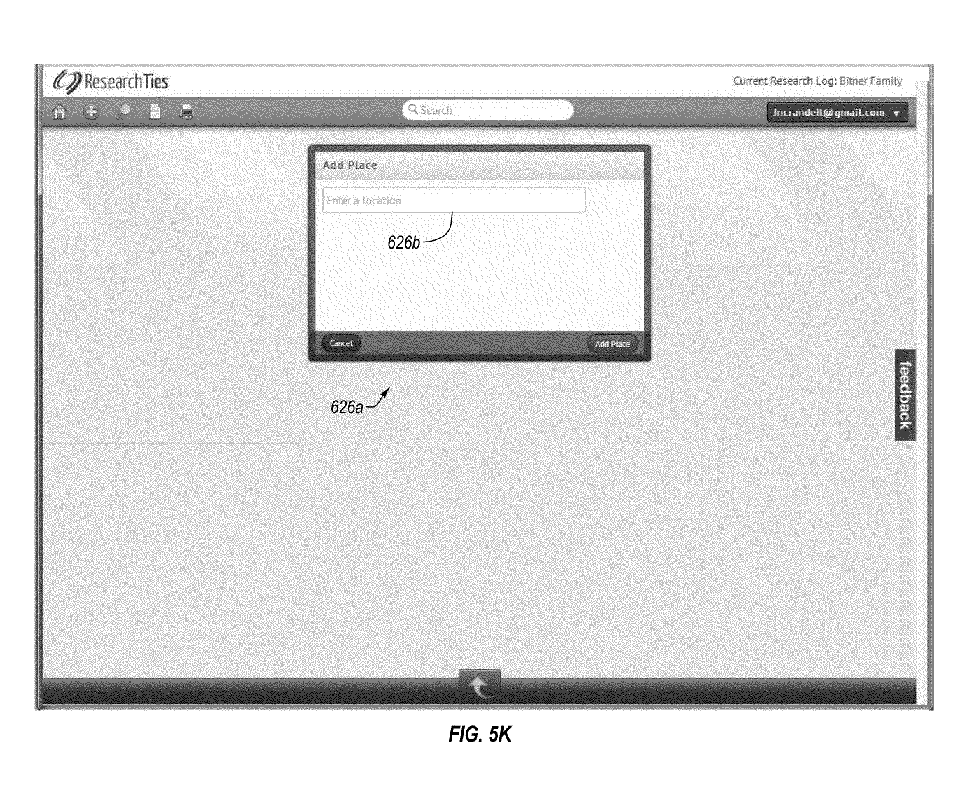

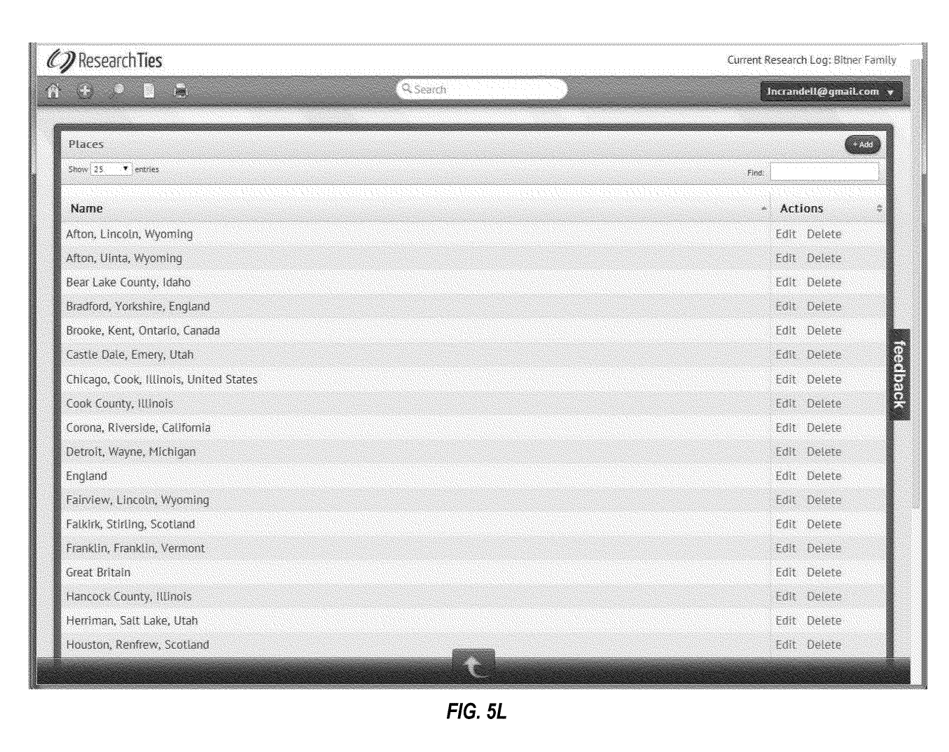

In connection with the performance of genealogical and historical research, the user may find it useful to create, save, modify, and/or refer to various types of lists, which may be used as items in the dropdown fields for data entry purposes. The subject matter of such lists is unlimited but can include, for example, any one or more of sources, repositories, individuals, families, surnames, places, and dates. As indicated in FIGS. 5-5l, discussed below, various methods and UIs can be used for performing a variety of processes with respect to such lists.

With reference first to FIG. 5, one example of a method for creating and/or modifying a list is denoted generally at 600. Similar to other methods and processes disclosed herein, the method 600 can begin at the home page where the user selects 602 “Add Information.” See, e.g., FIG. 4a and UI 503a. Next, the user can select 604 a list to modify. For example, the user can select one of the following lists: Add Source; Add Repository; Add Individual; Add Family; Add Surname; or, Add Place.

Once the list of interest has been selected, the user can then add 606 the desired information to that list. Following is a discussion of the aforementioned example lists, and some example processes for modifying those, such as by adding one or more additional items to one or more of the lists. Of course, items can be deleted from one or more lists as well, and list entries can be modified as desired.

When a user selects 604 the “Add Source” list to add the name of a source of genealogical materials to the list, the user can add 606 a variety of information to that list using a UI, such as the example UI 607a disclosed in FIG. 5a. Thus, the example UI 607a enables a user to use input elements 607b-k to specify, respectively, any one or more of the repository name, the surname of the author or the name of the corporation, the film/reel/frame number, additional citation details, a record type, the given name of the author, a call number, a URL of a website, or comments. It should be noted that when adding to the source list, a user can add both new repositories, and record types.

Once the source information has been entered, the new source can then be saved 608, and the user will then be returned 610 to the particular list (see FIG. 5b) that was selected 604 initially, the source list in this example. At this juncture, the user can then add 612 another item to the same list, edit 614 an item in the same list, or return 616 to the home page.

If the user returns 616 to the home page, the user can then select 604 the “Add Repository” list to add the name of a repository of genealogical materials to the list, the user can add 606 a variety of information to that list using a UI, such as the example UI 618a disclosed in FIG. 5c. Thus, the example UI 618a enables a user to use input elements 618b-h to specify, respectively, any one or more of the facility name, the address of the facility, the phone number of the facility, the name of a contact person at the facility, an email contact at the facility, a URL of the facility's website or online catalog, or comments concerning the facility.

Once the repository information has been entered, the entry can then be saved 608, and the user will then be returned 610 to the particular list (see FIG. 5d) that was selected 604 initially, the repository list in this example. At this juncture, the user can then add 612 another item to the same list, edit 614 an item in the same list, or return 616 to the home page.

If the user returns 616 to the home page, the user can then select 604 the “Add Individual” list to add the name of an individual to a list, such as a list of individuals that are of interest to the user in connection with planned or ongoing research. The user can add 606 a variety of information to that list using a UI, such as the example UI 620a disclosed in FIG. 5e. Thus, the example UI 620a enables a user to use input elements 620b-i to specify, respectively, any one or more of a given name, surname, birth date, death date, sex, personal ID, FamilySearch ID, or parent marriage ID.

Once the individual information has been entered, the new individual can then be saved 608, and the user will then be returned 610 to the particular list (see FIG. 5f) that was selected 604 initially, the individual list in this example. At this juncture, the user can then add 612 another item to the same list, edit 614 an item in the same list, or return 616 to the home page.

If the user returns 616 to the home page, the user can then select 604 the “Add Family” list to add the name of a family to a list, such as a list of families that are of interest to the user in connection with planned or ongoing research. The user can add 606 a variety of information to that list using a UI, such as the example UI 622a disclosed in FIG. 5g. Thus, the example UI 622a enables a user to use input elements 622b-f to specify, respectively, any one or more of a husband name, wife name, marriage date, place of marriage, or marriage ID. It should be noted that the user can also specify a new place for the marriage place and/or individual for the husband and/or wife of the family.

Once the family information has been entered, the new family can then be saved 608, and the user will then be returned 610 to the particular list (see FIG. 5h) that was selected 604 initially, the family list in this example. At this juncture, the user can then add 612 another item to the same list, edit 614 an item in the same list, or return 616 to the home page.

If the user returns 616 to the home page, the user can then select 604 the “Add Surname” list to add a surname to a list, such as a list of surnames that are of interest to the user in connection with planned or ongoing research. The user can add 606 a variety of information to that list using a UI, such as the example UI 624a disclosed in FIG. 5i. Thus, the example UI 624a enables a user to use input elements 624b and 624c to specify, respectively, any one or more of a surname and one or more alternate spellings for that surname.

Once the surname information has been entered, the new surname can then be saved 608, and the user will then be returned 610 to the particular list (see FIG. 5j) that was selected 604 initially, the surname list in this example. At this juncture, the user can then add 612 another item to the same list, edit 614 an item in the same list, or return 616 to the home page.

Finally, if the user returns 616 to the home page, the user can then select 604 the “Add Place” list to add a place to a list, such as a list of places that are of interest to the user in connection with planned or ongoing research. The user can add 606 a variety of information to that list using a UI, such as the example UI 626a disclosed in FIG. 5k. Thus, the example UI 626a enables a user to use input element 626b to specify a place of interest.

Once the place information has been entered, the new place can then be saved 608, and the user will then be returned 610 to the particular list (see FIG. 5l) that was selected 604 initially, the surname list in this example. At this juncture, the user can then add 612 another item to the same list, edit 614 an item in the same list, or return 616 to the home page.

### E. SEARCHING FOR OBJECTIVES

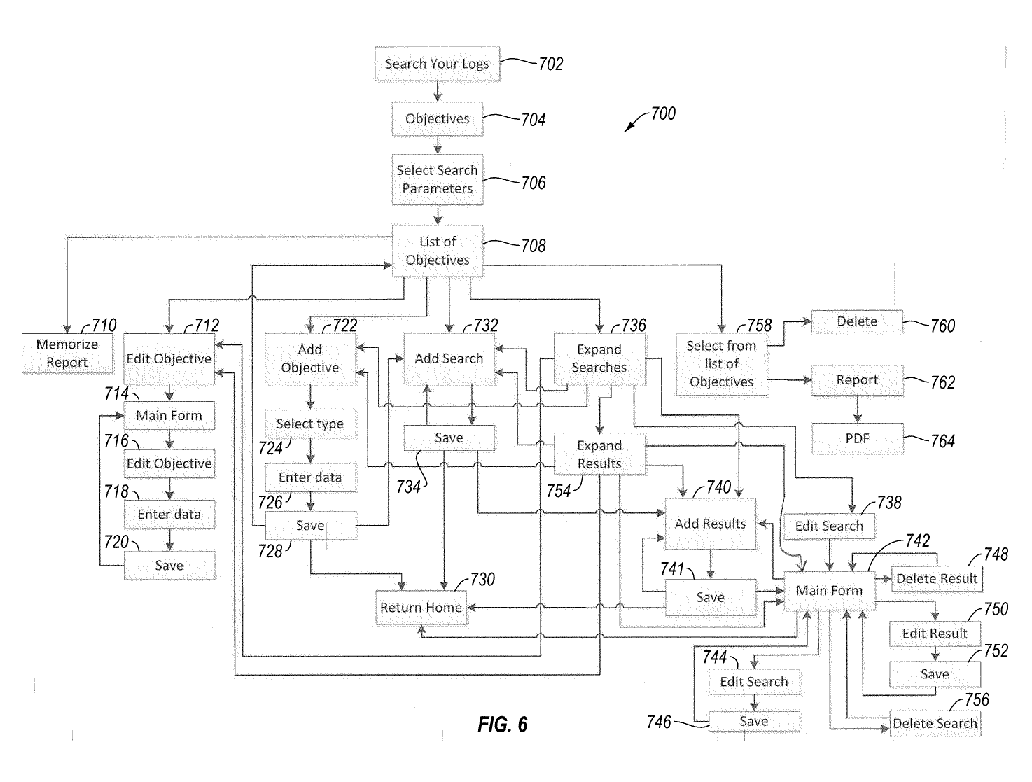

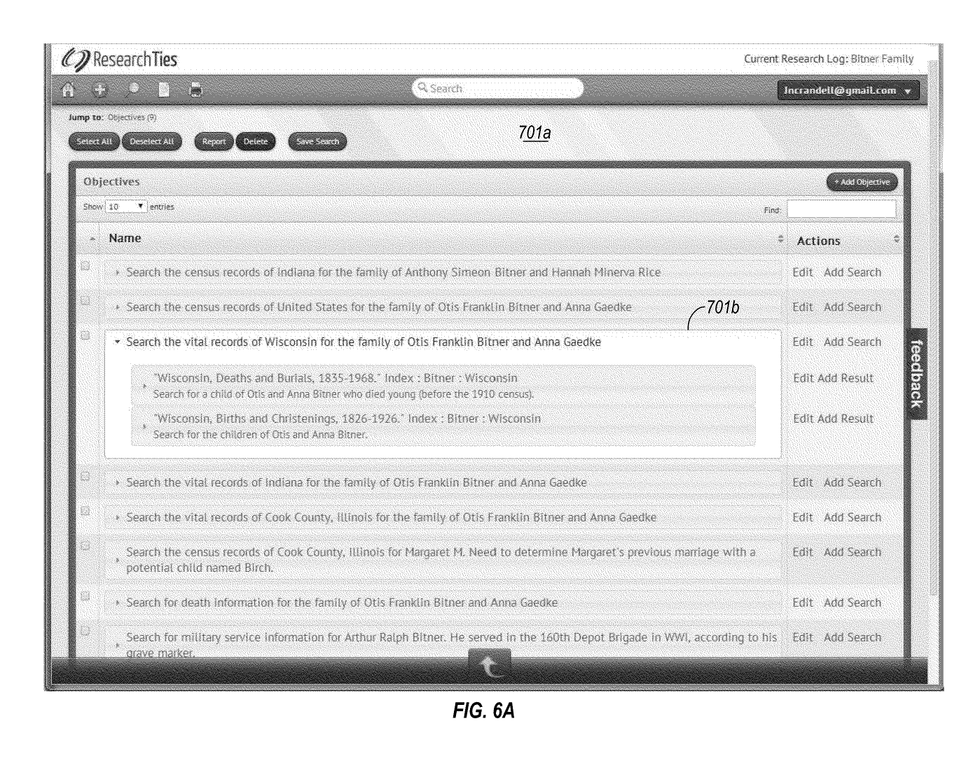

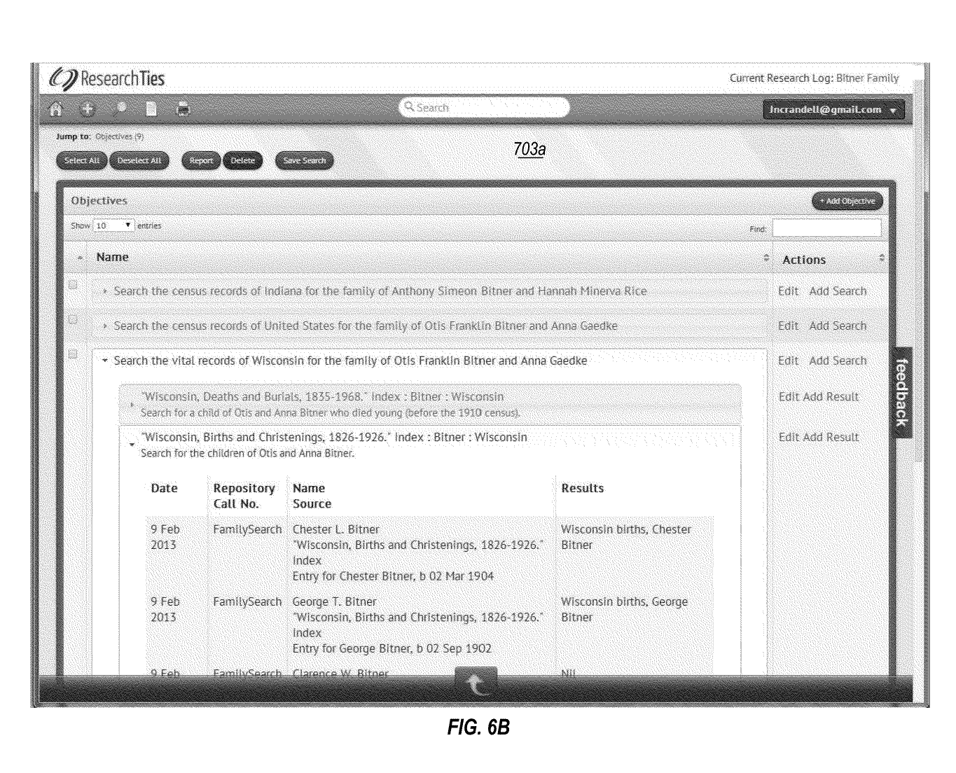

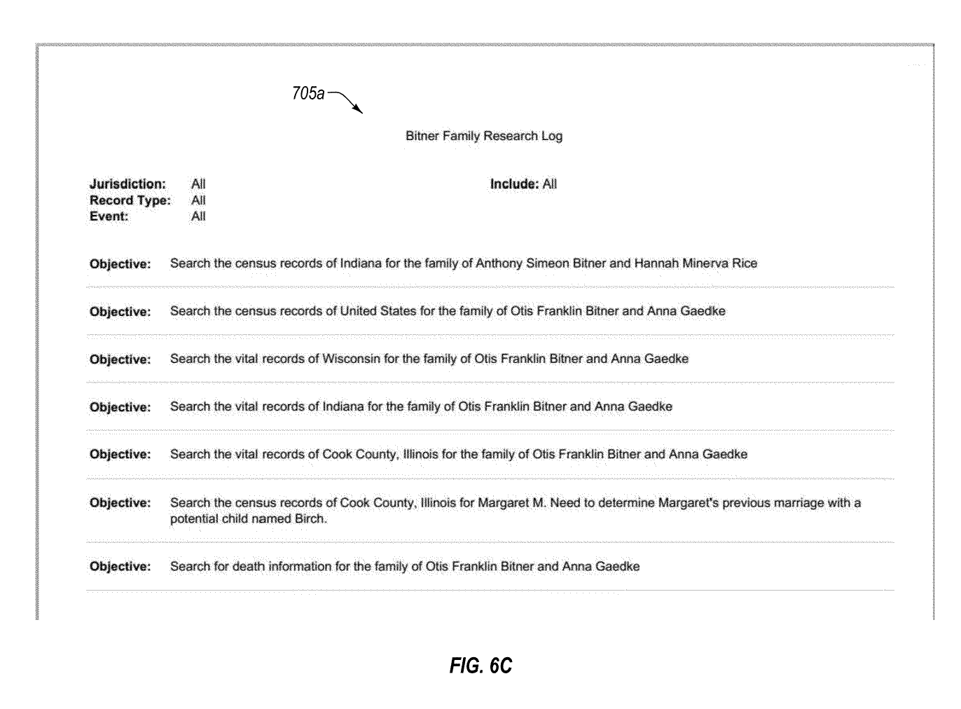

As noted above, for example, in the discussion of FIGS. 4-4o, and FIG. 4j in particular, a user may wish to find, and possibly select, any objectives that match defined parameters. The parameters can be selected by the user. The search can then be conducted and a list of conforming objectives identified. One or more objectives can then be selected from that list, and various operations performed with respect to the selected objective(s). Directing attention now to FIGS. 6-6c, details are provided concerning a method 700 for implementing one or more of the aforementioned functionalities. As in the case of other embodiments disclosed herein, some or all of the method 700 may be implemented using a UI presented, such as by a browser for example, to a user on a client computing device, although the scope of the invention is not limited to arrangements of this type.

Initially, a user may start from the home page (see FIG. 4a) and select 702 the “Search Your Logs” option. The user may then be presented 704 with a drop down menu (see FIG. 4j) that enables the user to initiate a process to find/select one or more objectives. The user can then select 706 one or more desired parameters (see FIG. 4j) and run the search. As a result of the search, one or more objectives that meet the input parameters will be returned 708 (see FIG. 4k).

At this juncture, the user has a number of options in terms of the operations that can be performed concerning one or more of the objectives returned in the list. These operations include, but are not limited to, memorizing a report, editing an objective, adding an objective, adding a search, expanding an objective to view attached searches, and selecting from a list of objectives. It should be noted that, at the option of the user, any one or more of these operations may be performed, or none of these operations may be performed. Each of these operations is considered in turn below.

One option available to the user after the list of objectives has been generated is to save, as shown in FIG. 6, the search results to memorize 710 the report. By doing this, the user can generate an updated list of conforming entries without having to re-enter the same parameters again next time the list is generated.

As noted above, the user also has the option to edit 712 one or more objectives returned 708 as a result of the search. For example, from a list such as that displayed in FIG. 4k, the user can select 712 the “Edit” button in the list to bring up the main form 714, then click on “Edit” 716 to bring up the corresponding objective. The user can then make any desired edits to the selected objective, such as by entering 718 any changes to the objective, and then the user can save 720 the edited objective. As indicated in FIG. 6, this process can be performed recursively, if desired.

Another option available to the user, and with continued reference to FIG. 6, is the option to add 722 one or more objectives to the returned list (see FIG. 4k) of objectives. This can be accomplished when the user selects the “Add Objective” button of the UI 533a. On the displayed objective ribbon (see, e.g., FIG. 4e), the user can select 724 the type of objective that is to be added to the list, and a corresponding template (see FIGS. 4b-4f) will open that enables the user to enter 726 the data for the new objective. Once the desired data has been entered 726 so as to formulate the objective, the user can then save 728 the objective. At this point, the process can return to 708, where the objective list, updated to include the newly formulated objective, is displayed. Additionally, or alternatively, the user can return 730 to the home page, or choose to add a new search 732, as discussed below.

In particular, and with continued attention to FIG. 4k and FIG. 6, a user can select “Add Search” to add a search to the objective to which the “Add Search” button corresponds. Upon selection 732 of “Add Search,” the user will be presented with a template, such as the example template 519a of FIG. 4h, which the user can then complete, and save 734. After the save has been completed, the process 700 can return home 730, or move to an “Add Results” process, discussed below.

Upon display 708 of the list of objectives, another option available to the user is to expand an objective 736 to view the searches associated with one or more of the listed objectives. In one example implementation, the user can simply select an objective of interest and the selected object will expand, as disclosed in the example UI 701a of FIG. 6a. In particular, by selecting the objective “Search the vital records of Wisconsin for the family of Otis Franklin Bitner and Anna Gaedke,” the user is presented with the two listed searches displayed in the window 701b of the UI 701a.

As further indicated in the UI 701a, the user can choose to “Edit” 738 a displayed search, and/or to “Add a Result” 740 to a displayed search. To edit 738 one of the displayed searches, the user can select “Edit” and will be returned 742 to a main editing form, such as the example displayed by the UI 547a of FIG. 4o. From the main editing form, the user can select “Edit” next to the search of interest, enter 744 one or more changes, and then save 746 the updated search. As further indicated in FIG. 6, the user also has the option, with respect to the displayed list of searches, to delete 748 a result associated with a displayed search, or edit 750 a result associated with a displayed search. Where a result is edited 750, the edited result can then be saved 752, at which point, the user may optionally return 742 to the main form. Finally, using the UI 547a, the user can choose to add 740 results to one or more displayed searches, and then save 741 those changes.

As noted above, and indicated in FIG. 6, once the list of searches has been expanded 736, the user also has the option to expand 754 the results associated with any of the displayed searches, and then view those results. This can be accomplished, for example, by way of a UI, such as the example UI 703a disclosed in FIG. 6b. As indicated in FIG. 6b, the user can then edit displayed results. In particular, selecting “Edit” to the right, in the UI 703a, of the displayed result returns 742 the user to the main form. From this form, and as discussed above, the user has the option to perform one or more of editing 712 an objective, editing 744 a search, adding 732 a search, deleting 756 the current search, adding 740 results, editing 750 results, or deleting 748 results.

With continued reference to FIG. 6, the user also has the option to select 758 an objective from the displayed 708 list of objectives. This can be accomplished, for example, by way of the UI 533a disclosed in FIG. 4k. To delete 760 one or more objectives, the user can check to the left of the objective(s) to be deleted, then select “Delete.”

As further indicated in FIG. 6, the user has the option to create a report. The report can be created in various formats including, but not limited to, portable document format (pdf) or spreadsheet (such as Excel®) format. More specifically, and by way of the UI 533a, the user can select one or more objectives by checking to the left of the desired objective(s), or by choosing “Select All,” and then selecting 762 “Report.” After the report has been generated 764, in pdf format for example, the report can then be saved to the local hard drive of a user and/or in a cloud storage location. An example of such a report is referenced at 705a in FIG. 6c.

### E. LOCATING SEARCHES

As noted elsewhere herein, it may be useful for a user to locate, view and/or edit, or delete one or more searches that were previously conducted, or at least formulated. Accordingly, and with attention now to FIG. 7, details are provided concerning an example method 800 for locating a search.

The method 800 may begin at the home page (see FIG. 4a) where a user selects 802 the “Search Your Logs” option of the UI 503a. Next, and with reference to the UI 543a of FIG. 4m, the user is presented with the “Find/Select” template and can then select 804 “Searches” from the drop down menu. The user then selects 806 the desired parameters for finding the search(es) of interest, and initiates the search.

As a result of the search, a list of any conforming search(es) will be returned 808. One example of such a list is indicated in UI 545a of FIG. 4n. Once the user has obtained a list of conforming searches, a variety of different operations can be performed with respect to those searches.

One such operation is memorization 810 of the list of searches that have been returned. This operation may be useful in that it enables the user to later generate an updated list of conforming searches without having to re-enter the same parameters again that resulted in the initial list of conforming searches.

Another option available to the user after the list of conforming searches has been returned 808 is to select 812 one or more searches from the list for inclusion in a report. With reference again to FIG. 4n, and with continued reference to FIG. 7, the user can select one or more of the displayed searches and then create 814 a report that includes those searches by selecting “Report” in the UI 545a. As with the other reports disclosed herein, this report can be generated in any suitable format, one example of which is a .pdf format. After the report has been generated, it can then be saved 816 to a local hard drive of a user and/or to a cloud storage location. As suggested earlier, one or more searches in the list of conforming searches may be deleted if desired. Thus, at the selection 812 stage, the user can select one or more searches to be deleted, and then delete 818 the selected searches. At this point, the user can return 820 home to the home page either automatically, or by choice.

With continued reference to FIG. 7, the user can also choose to edit one or more of the searches displayed by the UI 545a in the returned 808 list of searches. For example, the user can select “Edit” 821 next to a search of interest, which then returns 822 the user to the main form displayed by UI 547a (see FIG. 4o). At the main form, the user can then select 824 “Edit” from the “Search” bar and the user is then presented with the UI 519a of FIG. 4h which enables the user to enter 826 the desired changes. The changes can then be saved 828 and the user can return 820 to the home page.

From the main form which, as noted above, can be reached by selecting “Edit” 821, the user can also delete 830 a search from the current objective, or add 832 a search to the same objective. Once one or more searches are added 832, they can then be saved 834, and the user can return 820 to the home page.

### F. SEARCHING FOR RESULTS

With attention now to FIG. 8, an example method 900 is disclosed for searching for the results of research that has been conducted. From the home page, and as disclosed in the UI 503a of FIG. 4a, the user can select 902 the “Search Your Logs” option from the menu, and will then be presented with a “Find/Select” template such as that displayed by the example UI 903a of FIG. 8a. From that template, the user can then select 904 “Results” from the drop down menu and then select 906 one or more search parameters. Once the parameters have been entered, a search is then conducted and a list of results produced 908, as shown in the example UI 909a of FIG. 8b. The list of results comprises any and all results, if any, that conform with the input parameters upon which the search was based. Once the list of results has been produced, a variety of operations can be performed with respect to those results.

As one example of such an operation, the user can save the search results to memorize 910 a report. As noted elsewhere herein, memorization can allow the user to later generate an updated list of conforming results without having to re-enter the search parameters again.

As another example of operations that can be performed with respect to the results, one or more of the listed results can be selected 912 for deletion 914, or for creation 916 of a report. For example, and with reference to the UI 909a of FIG. 8b, the user can select a checkbox next to a listing of interest, or can “Select All” to identify the results that are to be deleted by selection of the “Delete” button, or that are to be combined to generate a report by selection of the “Report” button. If the latter, the resulting report can be saved 918, such as in a .pdf format for example, on the local hard drive of a user and/or in a cloud storage location. One example of such a report is disclosed as example report 919a of FIG. 8c. The format of the report 919A is presented solely by way of example and it should be understood that other formats can be used and the scope of the invention is not limited to the example of FIG. 8c.

With continued reference to FIG. 8, another option available to the user when presented with the list of results such as shown in UI 909a of FIG. 8b is to edit 920 one or more of the listed results. This can be accomplished by selecting the “Edit” button next to the result(s) of interest, which will then return 922 the user to the main form such as is disclosed in the UI 547a of FIG. 4o. Once at the main form, the user can edit 924 the selected results, and then save 926 the edited results.

### G. “TO DO” LISTS

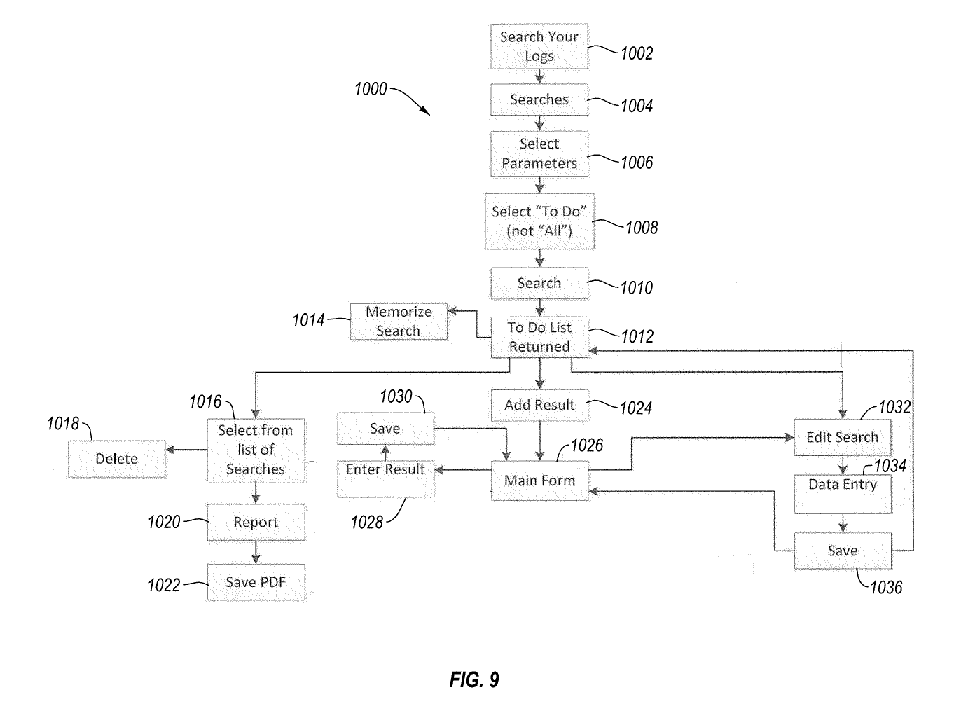

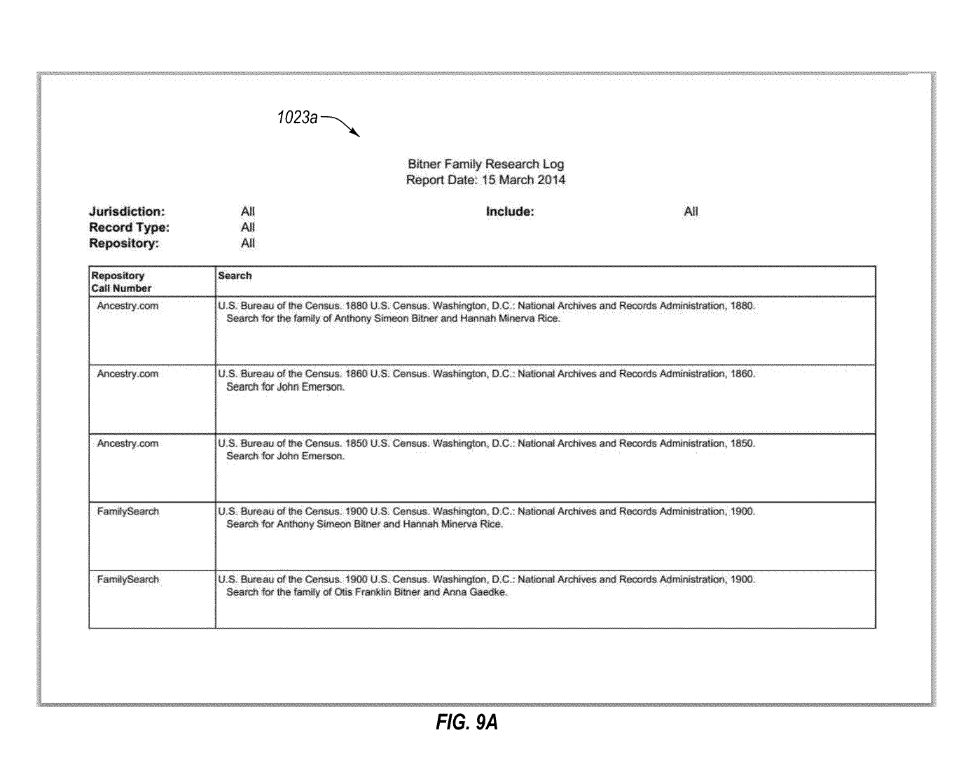

With attention now to FIG. 9, an example method 1000 is disclosed for creating a “to do” list. Such a list may prove useful for a researcher who, during the course of research, identifies a variety of different tasks that will be required, and who wishes to store a listing of the tasks where they can be retrieved and referred to, as well as modified.

As indicated in FIG. 9, the method 1000 may begin where a user at the home page (see UI 503a at FIG. 4a) selects 1002 the “Search Your Logs” option. In the “Find” dropdown box that is displayed as a result (see UI 543a at FIG. 4m), the user can choose 1004 to select the “Searches” option, and then enter 1006 any desired search parameters, examples of which are shown in FIG. 4m. In the “Include” area of the UI 543a, the user can then select 1008 the “To Do” option, and then select 1010 to run the “Search” option.

After the search has been run 1010, a list of hits that conform with the input parameters is returned 1012. At this point, the user can memorize 1014 the results of the “Find/Select” process without having to set the search parameters again. This functionality may be particularly useful, for example, in that it can enable a researcher to generate their “to do” list for a repository that the researcher visits frequently.

Once the “to do” list has been generated (see, e.g., UI 545a of FIG. 4n), the user has a variety of different options that can be pursued. For example, the user may choose to select 1016 one or more searches from the list to be deleted 1018. Alternatively, the user may choose to select 1016 one or more searches from the list to generate 1020 a report which can then be saved 1022 in a .pdf or other format. An example report format 1023a is shown in FIG. 9a.

Another option available to the user after the “to do” list has been generated 1012, is that the user can add 1024 one or more results to that list by selecting “Add Result” for the search that is being conducted. As a result of this selection, the user is taken 1026 to the main form (see UI 547a of FIG. 4o) where the user can then enter 1028 the result of the search, and save 1030 the result. It should be noted that when entering a result, the user may optionally add a new individual. After the result is saved 1030, the user can return 1026 to the main form and, from there, perform any one or more of the other main form functions disclosed elsewhere herein, including the “Edit Search” option discussed below.

Finally, and as indicated in FIG. 9, the user also has the option, after the “to do” list has been generated 1012, to edit 1032 the search. When editing the search, the user has the option to edit 1034 the source, surname, record type, and/or jurisdiction. As well, when editing a source, a new repository can be added, and when a new surname is added, alternate spellings of the surname can be specified. Once the data entry 1034 has been completed, the edited search can then be saved 1036, and the user returned 1026 to the main form.

### H. EXAMPLE COMPUTING DEVICES AND MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media.

Computer-executable instructions comprise, for example, instructions and data which cause a general purpose computer, special purpose computer, mobile phone, tablet, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modulates running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, and/or other devices may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for collecting and processing genealogical and historical information, the method comprising:
defining, at a client device, an objective, wherein the objective includes any one or more of conducting a preliminary survey of genealogical information, searching a record group, identifying a particular person, finding event information, or conducting a locality survey of historical information;
defining, at the client device, a search, and requesting association of the search with the objective;
defining, at the client device, search results generated by the search;
requesting, by the client device, association of the search results with the defined search; and
finding, by the client device, in a log previously created by the user, any one or more of objectives, searches, and results previously defined and recorded by the user.

2. The method as recited in claim 1, wherein the defined search comprises a plurality of search variables.

3. The method as recited in claim 2, wherein the plurality of search variables are collectively associated with a plurality of search logs that existed prior to the time the search was executed.

4. The method as recited in claim 2, wherein the plurality of search variables are collectively associated with a single search log that existed prior to the time the search was executed.

5. The method as recited in claim 1, wherein the plurality of search variables include any two or more of a person, a family, a surname, a place, a record type, an event, a source, a repository, a date, a researcher, or a keyword.

6. The method as recited in claim 1, wherein the associated materials comprise one or more of a URL link, and an electronic file.

7. The method as recited in claim 1, further comprising performing, at the client device, after finding any one or more of the objectives, searches, and results previously defined and recorded by the user, retrieving and modifying any one or more of the objectives, searches, and results previously defined and recorded.

8. The method as recited in claim 1, further comprising, presenting, by the client device, a user interface (UI) to a user, wherein at least part of the method is performed by way of the user interface.

9. The method as recited in claim 1, further comprising, storing or causing the retrievable storage of, by the client device, any one or more of objectives, searches, and search results.

10. A method for collecting and processing genealogical and historical information, the method comprising:
receiving, by a server, a definition of an objective, wherein the objective includes any one or more of conducting a preliminary survey of genealogical information, searching a record group, identifying a particular person, finding event information, or conducting a locality survey of historical information;
receiving, by the server, a definition of a search;
receiving, by the server, a request for association of the defined search with the objective;
associating, by the server, the defined search with the objective;
receiving, by the server, search results associated with the defined search;
receiving, by the server, a request for association of the search results with the defined search; and
associating, by the server, the search results with the defined search.

11. The method as recited in claim 10, further comprising:
receiving, by the server, one or more of a URL link or electronic file;
receiving, by the server, a request for association of the received URL link and/or electronic file with the search results; and
associating, by the server, the received URL link and/or electronic file with the search results.

12. A server, comprising:
a research application operable to communicate with a research client on a client device;
one or more hardware processors; and
computer-executable instructions residing on physical media, wherein the computer-executable instructions, when executed by one or more of the hardware processors perform the method of claim 10.

13. A physical storage device having stored therein computer-executable instructions in the form of a research client application, and the computer-executable instructions, when executed by one or more hardware processors of a computing system, perform collection and processing of historical and genealogical information, wherein the collection and processing of historical and genealogical information comprises:
defining an objective, wherein the objective includes any one or more of conducting a preliminary survey of genealogical information, searching a record group, identifying a particular person, finding event information, or conducting a locality survey for historical information;
defining a search, and requesting association of the search with the objective;
defining search results generated by the search;
requesting association of the search results with the defined search; and
finding, in a log previously created by the user, any one or more of objectives, searches, and results previously defined and recorded by the user.

14. The physical storage device of claim 13, wherein the defined search comprises a plurality of search variables.

15. The physical storage device of claim 14, wherein the plurality of search variables are collectively associated with a single search log that existed prior to the time the search was executed.

16. The physical storage device of claim 13, wherein the plurality of search variables include any two or more of a person, a family, a surname, a place, a record type, an event, a source, a repository, a date, a researcher, or a keyword.

17. The physical storage device of claim 13, wherein the associated materials comprise one or more of a URL link, and an electronic file.

18. The physical storage device of claim 13, wherein the collection and processing of historical and genealogical information further comprises performing, after finding any one or more of the objectives, searches, and results previously defined and recorded by the user, retrieving and modifying any one or more of the objectives, searches, and results previously defined and recorded.

19. The physical storage device of claim 13, wherein the collection and processing of historical and genealogical information further comprises storing or causing the retrievable storage of, any one or more of objectives, searches, and search results.

20. The physical storage device of claim 13, wherein the physical storage device is included in one of a laptop computer, tablet device, desktop computer, server, or mobile phone.
